(19) United States
(12) Patent Application Publication
(10) Pub. No.: US 2015/0025190 A1
(43) Pub. Date: Jan. 22, 2015

(54) FLAME RETARDANT PALLET

(71) Applicant: CIP Binani, Inc., Winona, MN (US)

(72) Inventors: Darin J. Grinsteinner, Holmen, WI (US); Larry E. Tiedermann, Winona, MN (US); Ronald C. Hawley, Winona, MN (US)

(73) Assignee: CIP Binani, Inc., WINONA, MN (US)

(21) Appl. No.: 14/376,174

(22) PCT Filed: Feb. 12, 2013
(86) PCT No.: PCT/US13/25759

§ 371 Date: Aug. 1, 2014

Related U.S. Application Data
(60) Provisional application No. 61/598,150, filed on Feb. 13, 2012.

(51) Int. Cl. C08K 3/34; B29C 43/00; B29C 43/34; C08K 3/22

(52) U.S. Cl. CPC C08K 3/34; C08K 3/22; B29C 43/003; B29C 43/34; C08K 2003/2224; B29K 2995/0016; B29K 2105/10
USPC 524/436; 264/299; 264/331.15

(57) ABSTRACT

A flame retardant pallet that includes at least one structural component formed from a polymeric composite material. The polymeric composite material includes 35 weight percent (wt. %) to 78 wt. % of a polyolefin; 20 wt. % to 50 wt. % of a long glass fiber reinforcement; 0.5 wt. % to 3 wt. % of a coupling agent coupling the long glass fiber reinforcement to the polyolefin; and up to 25 wt. % of a flame retardant, wherein the wt. % values of the polymeric composite material are based on a total weight of the polymeric composite material and total to a value of 100 wt. %, and the polymeric composite material used to form the structural component has a specific strength of at least 55 kN·m/kg and a specific stiffness of at least 3500 kN·m/kg as tested according to ASTM D638-10 (tensile strength) and D790-00 (flex modulus), which were each divided by the specific gravity (determined through ASTM D792-08) to arrive at the given values.

### FIELD OF THE DISCLOSURE

The disclosure is directed to a pallet, and more particularly to a flame retardant pallet.

### BACKGROUND

The pallet industry is in need of a pallet that can comply with at least one of the six pallet dimensions sanctioned by the International Organization for Standardization (ISO) under the ISO Standard 6780 and that also (1) weighs 60 pounds (27.2 kg) or less, (2) can meet the requirements of Underwriters Laboratories (UL) 2335 “Fire Test of Storage Pallets,” (3) can be rebuilt and (4) can meet the Virginia Tech Sample Pallet Design Evaluation testing procedure, which includes ASTM D1185 (Standard Test Methods for Pallet and Related Structures Employed in Materials Handling and Shipping) and ISO 8611 (Pallet for Materials Handling Parts 1 and 2). To date, no pallet has been created that can meet these needs.

### SUMMARY

The present disclosure provides for a flame retardant pallet that meets at least one of the six pallet dimensions sanctioned by the International Organization for Standardization (ISO) under the ISO Standard 6780, that weighs 60 pounds (27.2 kilograms) or less, that may meet the requirements of Underwriters Laboratories (UL) 2335 “Fire Tests of Storage Pallets,” and that can be rebuilt. In addition, the flame retardant pallet of the present disclosure may also meet the International Organization for Standardization (ISO) 8611 static test methods 8.4 (Fork Lifting Tests), 8.6 (Stacking Test) and 8.7 (Dead-Weight Bending Test), among others. The flame retardant pallet of the present disclosure may also meet the Virginia Tech Sample Pallet Design Evaluation testing procedure, which includes ASTM D1185 (Standard Test Methods for Pallet and Related Structures Employed in Materials Handling and Shipping) and ISO 8611 (Pallet for Materials Handling Parts 1 and 2).

The flame retardant pallet of the present disclosure includes at least one structural component formed from a polymeric composite material. The polymeric composite material used in forming the structural components has 35 weight percent (wt. %) to 78 wt. % of a polyolefin; 20 wt. % to 50 wt. % of a long glass fiber reinforcement; 0.5 wt. % to 3 wt. % of a coupling agent coupling the long glass fiber reinforcement to the polyolefin; and up to 25 wt. % of a flame retardant, wherein the wt. % values of the polymeric composite material are based on a total weight of the polymeric composite material and total to a value of 100 wt. %. The polymeric composite material used to form the structural component has a specific strength of at least 55 kN-m/kg and a specific stiffness of at least 3500 kN·m/kg as tested according to ASTM D638-10 (tensile strength) and D790-00 (flex modulus), which were each divided by the specific gravity (determined through ASTM D792-08) to arrive at the given values.

For the various embodiments, the flame retardant pallet of the present disclosure weighs from 35 pounds (15.9 kilograms (kg)) to 60 pounds (27.2 kg). Among other polymers, the polyolefin used in the polymeric composite material can be polypropylene. With respect to the flame retardant, the polymeric composite material can include 0.1 to less than 8 wt. % of the flame retardant. For the various embodiments, the flame retardant can be magnesium hydroxide. The coupling agent of the polymeric composite material can be maleic anhydride.

The polymeric composite material forming at least one structural component can also include 45 wt. % to 57.4 wt. % of the polyolefin; 30 wt. % to 50 wt. % of the long glass fiber reinforcement; 0.5 wt. % to 3 wt. % of the coupling agent; and 0 wt. % of the flame retardant. In an additional embodiment, the polymeric composite material forming at least one structural component can include 53 wt. % to 69.6 wt. % of the polyolefin; 20 wt. % to 30 wt. % of the long glass fiber reinforcement; 0.5 wt. % to 1.5 wt. % of the coupling agent; and 0.1 wt. % to 7.9 wt. % of the flame retardant. In an additional embodiment, the polymeric composite material includes 52 wt. % to 59 wt. % of the polyolefin; 20 wt. % to 30 wt. % of the long glass fiber reinforcement; 1.0 wt. % to 3 wt. % of the coupling agent; and 8 wt. % to 15 wt. % of the flame retardant.

For the various embodiments, the polyolefin can include polypropylene, the coupling agent can include maleic anhydride and the flame retardant can include magnesium hydroxide. At least one structural component of the flame retardant pallet can be selected from the group consisting of a bottom deck, a top deck, a deck spacer and combinations thereof. Embodiments of the present disclosure also include a method of forming at least one component of a pallet. The method can include extruding the polymeric composite material comprising 35 wt. % to 78 wt. % of a polyolefin; 20 wt. % to 50 wt. % of a long glass fiber reinforcement; 0.5 wt. % to 3 wt. % of a coupling agent that couples the long glass fiber reinforcement to the polyolefin; and up to 25 wt. % of a flame retardant, wherein the wt. % values of the polymeric composite material are based on a total weight of the polymeric composite material and total to a value of 100 wt. %; and molding the at least one structural component from the polymeric composite material. Molding the at least one structural component, as provided herein, can include transfer molding the at least one structural component. Structural components can be used to form the flame retardant pallet of the present disclosure. Each of the structural components can be removed from the flame retardant pallet and replaced as needed.

### BRIEF DESCRIPTION OF THE DRAWING

The drawings may not be to scale.

FIG. 1 is an exploded view of a flame retardant pallet according to the present disclosure.

FIG. 2 is a cross sectional view of the bottom deck, the top deck and the deck spacer joined by the mechanical fastener according to the present disclosure.

FIG. 3 is a view of a pallet according to the present disclosure.

FIG. 4A is a heat release curve (tested according to ASTM E11354-09: E1354-09) of a high density polyethylene based sample used in a pallet known to pass UL 2334.

FIGS. 4B and 4C is a heat release curve (tested according to ASTM E1354-09: E1354-09) of Examples 1 and 2 of the polymeric composite material according to the present disclosure.

FIG. 5 is an exploded view of a flame retardant pallet according to the present disclosure.

FIG. 6A is a view of the underside of the top deck of the flame retardant pallet of FIG. 5 according to the present disclosure.

FIG. 6B is a view of the topside of the bottom deck of the flame retardant pallet of FIG. 5 according to the present disclosure.

FIG. 7A is a perspective view of a deck spacer of the flame retardant pallet of FIG. 5 according to the present disclosure.

FIG. 7B is a perspective view of a corner spacer of the flame retardant pallet of FIG. 5 according to the present disclosure.

FIG. 8 is a cross-sectional view of a deck spacer, the bottom deck and the top deck of the flame retardant pallet of FIG. 5 according to the present disclosure.

### DEFINITIONS

As used herein a pallet is a transport structure having a top deck, a bottom deck and deck spacers between the top deck and bottom deck, where the top deck supports items while being lifted and/or moved by a forklift, pallet jack, front loader or other jacking device.

As used herein, a “flame retardant pallet” means a pallet that includes compounds that help to inhibit or resist the spread of fire.

As used herein, a polyolefin refers to a polymer formed from an olefin, which can be an acyclic and/or a cyclic hydrocarbon each having one or more carbon-carbon double bonds, apart from the formal ones in aromatic compounds.

As used herein, a flame retardant is a compound that is used to inhibit or resist the spread of fire.

As used herein, the term “specific strength” refers to a material's strength (force per unit area at failure) divided by its density. It is also known as the strength-to-weight ratio or strength/weight ratio. Specific strength is tested according to ASTM D638-10 (tensile strength) and ASTM D792-08 (specific gravity), where the tensile strength is divided by the specific gravity to arrive at the specific strength. As used herein, the term “specific stiffness” refers to a materials property consisting of the elastic modulus per mass density of a material. It is also known as the stiffness to weight ratio or specific stiffness. Specific stiffness is tested according to ASTM D790-00 (flex modulus) and ASTM D792-08 (specific gravity), where the flex modulus is divided by the specific gravity to arrive at the specific stiffness.

As used herein, the phrase “melt flow index” is a measure of the ease of flow of the melt of a thermoplastic polymer. It is defined as the mass of polymer, in grams, flowing in ten minutes through a capillary of a specific diameter and length by a pressure applied via prescribed alternative gravimetric weights for alternative prescribed temperatures according to ASTM D1238.

As used herein, an “aspect ratio” is the proportional relationship between the diameter of a fiber and its length.

As used herein, transfer molding is a process where the amount of a molding material (e.g., the polymeric composite material of the present disclosure) is measured and inserted into a compression mold before molding under pressure takes place.

As used herein, a direct long fiber thermoplastic process provides for continuous feeding of glass-fiber into a screw extruder containing a polyolefin composition in a molten state, where the glass-fiber and the polyolefin form a composite material that is either processed by compression molding, transfer molding, or injection molding.

As used herein, the abbreviation “kg” stands for kilogram. As used herein, the abbreviation “kN” stands for kiloNewton. As used herein, the abbreviation “m” (e.g., as used in kN·m/kg) stands for meter. As used herein, the abbreviation “cm” stands for centimeter. As used herein, the abbreviation “mm” stands for millimeter. As used herein, the abbreviation “g” stands for grams. As used herein, the abbreviation “MPa” stands for megapascals. As used herein, the abbreviation “in” stands for inch(es). As used herein, the abbreviation “sec” stands for second(s). As used herein, the abbreviation “min” stands for minute(s). As used herein, the abbreviation “psi” stands for pounds per square inch. As used herein, the abbreviation “lbf” stands for pound-force. As used herein, the abbreviation “cc” stands for cubic centimeters. As provided herein the weight percent (wt. %) values of the polymeric composite material of the embodiments provided herein are based on a total weight of the polymeric composite material, where the weight percents of the components (e.g., the polyolefin, the long glass fiber reinforcement, the coupling agent, the flame retardant, and, optionally, the filler) used in forming the polymeric composite material total to a value of 100 wt. %.

### DETAILED DESCRIPTION

The flame retardant pallet of the present disclosure is directed to the solution of known problems associated with both conventional wood pallets and polymer based pallets. The present disclosure provides for a flame retardant pallet that meets at least one of the six pallet dimensions sanctioned by the International Organization for Standardization (ISO) under the ISO Standard 6780, has a weight of 60 pounds (27.2 kg) or less, may meet the requirements of Underwriters Laboratories (UL) 2335 “Fire Tests of Storage Pallets,” and can be rebuilt. In addition, the flame retardant pallet of the present disclosure may also meet the International Organization for Standardization (ISO) 8611 static test methods 8.4 (Fork Lifting Tests), 8.6 (Stacking Test) and 8.7 (Dead-Weight Bending Test), among others. The flame retardant pallet of the present disclosure may also meet the Virginia Tech Sample Pallet Design Evaluation testing procedure, which includes ASTM D1)1185 (Standard Test Methods for Pallet and Related Structures Employed in Materials Handling and Shipping) and ISO 8611 (Pallet for Materials Handling Parts 1 and 2).

Embodiments of the present disclosure may also provide for a flame retardant pallet that may meet the requirements of one or more of the Factory Mutual (FM Global) FM Approval Standard for Classification of Idle Plastic Pallets as Equivalent to Wood Pallets (FM/ANSI 4996); Grocery Manufacturers Association (GMA) Recommendations on the Grocery Industry Pallet System; International Organization of Standardization (ISO) ISO 8611-1:2004 Pallets for materials handling—Flat pallets; American Society of Testing and Materials (ASTM) ASTM D1185-98a (2009) Standard Test Methods for Pallets and Related Structures Employed in Materials Handling and Shipping; Underwriters Laboratories, Inc. SU 2417, Physical Performance Tests of Storage Pallets; U.S. Department of Labor, Occupational Safety & Health Administration (OSIRA) OSHA 3192-06N, Guidelines for Retail Grocery Stores, Ergonomics for the Prevention of Musculoskeletal Disorders; GMI, and the International Mass Retail Association (IMRA); and/or US Environmental Protection Agency (US EPA)—TSCA (Toxic Substances Control Act), US Chemical Management; NSF International (National Sanitation Foundation) NSF/ANSI 2 Food Equipment; RFID—Radio Frequency Identification, Electronic Product Code (EPC) Material (signal) compatibility GPC, RTI (Pallet Tagging) Guideline, Issue 2, Approved, September-2010; Avery Dennison (AD-224 RFID Inlays)—Environmentally protected tag packaging (internal placement), International Plant Protection Convention (IPPC) Exemption from US Department of Agriculture (USDA), Animal Plant Health Inspection Service (APHIS), International Standards for Phytosanitary Measures, (ISPM) No. 15 [2009] Regulation of wood packaging material in international trade, all of which are incorporated herein by reference in their entirety.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process and/or structural changes may be made without departing from the scope of the present disclosure.

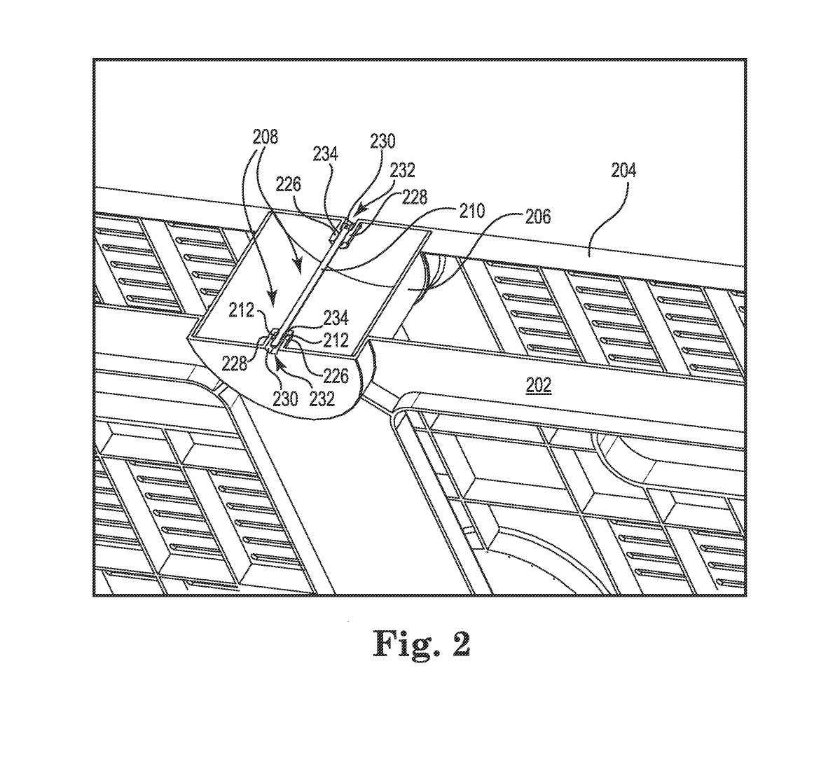

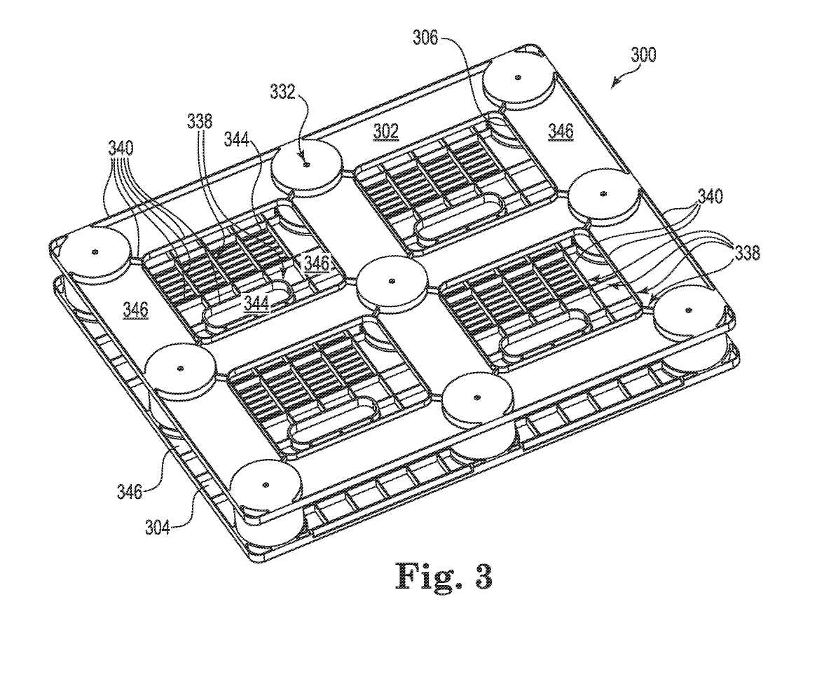

The figures herein follow a numbering convention in which the first digit or digits correspond to the drawing figure number and the remaining digits identify an element or component in the drawing. Similar elements or components between different figures may be identified by the use of similar digits. For example, 214 may reference element “14” in FIG. 2, and a similar element may be referenced as 314 in FIG. 3. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

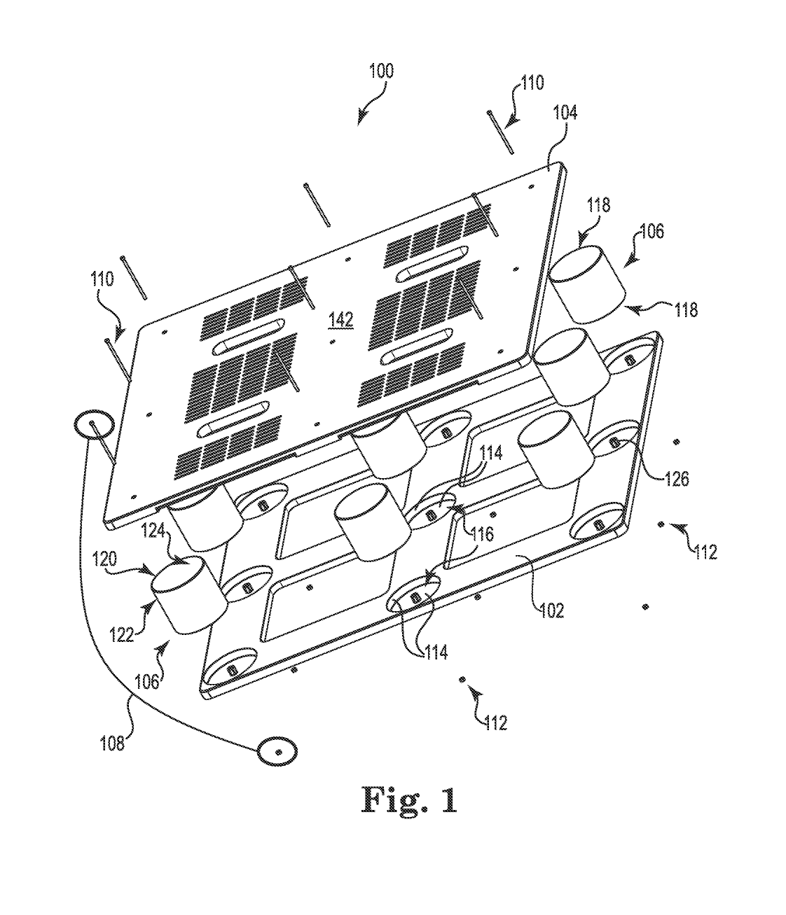

FIG. 1 provides an exploded view of a flame retardant pallet 100 according to the present disclosure. As illustrated, the flame retardant pallet 100 includes a variety of structural components that are reversibly assembled in forming the flame retardant pallet 100. Specifically, the flame retardant pallet 100 includes a bottom deck 102, a top deck 104, and a deck spacer 106. As illustrated, the flame retardant pallet 100 includes a plurality (e.g., nine) of the deck spacers 106. Fewer deck spacers 106, or more deck spacers 106 can be used in the flame retardant pallet 100, as desired.

The flame retardant pallet 100 also includes a mechanical fastener 108. The mechanical fastener 108 passes through a portion of the deck spacer 106 to releasebly join the bottom deck 102 and the top deck 104. Examples of the mechanical fastener 108 can include, but are not limited to, a bolt 110 and a nut 112 assembly (as illustrated in FIG. 1), a snap joint, and/or a screw or a bolt that can engage a threaded element or surface in either the bottom deck 102 or the top deck 104. Other configurations are also possible. The mechanical fastener 108 can be formed of a metal (e.g., aluminum), a metal alloy (e.g., stainless steel), a polymer and/or a polymer composite (e.g., the polymeric composite material as provided herein).

The bottom deck 102 and the top deck 104 also include a surface 114 defining a socket 116. The socket 116 can receive at least a portion of the deck spacer 106, where an end 118 of the deck spacer 106 can at least partially seat against the surface 114 of the socket 116. As illustrated, the deck spacer 106 has a wall 120 with an outer surface 122 and an inner surface 124 that define a tubular configuration. When seated in the socket 116, the outer surface 122 can be at least partially in contact with the surface 114 defining the socket 116. In one embodiment, the socket 116 helps to align and position the deck spacer 106 relative the bottom deck 102 and the top deck 104. It is also possible that the deck spacer 106 can further include radial support members extending from the inner surface 124 to either other portions of the inner surface 124 and/or a concentrically positioned tube that can help to guide the mechanical fastener 108 through the deck spacer 106.

Referring now to FIG. 2, there is shown a cross sectional view of the bottom deck 202, the top deck 204 and the deck spacer 206 joined by the mechanical fastener 208. As illustrated, each of the bottom deck 202 and the top deck 204 include a fastener guide 226 (also shown as 126 in FIG. 1). The fastener guide 226 includes a wall 228 having a surface 230 that declines an opening 232 through which at least a portion of the mechanical fastener 208 can pass. The surface 230 also includes a ledge 234 that can receive and seat at least a head 236 of the mechanical fastener 208 and the nut 212, where the nut 212 has threads that can engage threads on the bolt 210. Washers and/or washer head bolts can be used with either the nut 212 and/or the bolt 210 if desired.

Referring now to FIG. 3, there is shown a view from underneath the flame retardant pallet 300. This view helps to illustrate a frame structure 338 present on both the bottom deck 302 and the top deck 304. The frame structure 338, in conjunction with the polymeric composite material of the present disclosure discussed herein, can be designed in such a way so as to help impart, among other things, the strength and rigidity that may allow the flame retardant pallet to meet the ISO 8611 static test methods 8.4 (Fork Lifting Tests), 8.6 (Stacking Test) and 8.7 (Dead-Weight Bending Test), among others.

As illustrated in FIG. 3, the frame structure 338 includes cross-beams 340 arranged and supported by each other. For example, the cross beams 340 are provided in a pattern that helps to distribute a load from items placed on an upper surface (shown at 142 in FIG. 1) of the top deck 304 and transfer that load through the deck spacers 306 to the bottom deck 302. The upper surface (142 in FIG. 1) of the top deck 304 can also define openings 344 through the top deck 304. The bottom deck 302 and the top deck 304 also include a skin 346 between the cross beams 340. In one embodiment, the skin 346 helps to define the upper surface (142 in FIG. 1) of the top deck 304.

The number, relative position and dimensions of the cross-beams 340 on both the bottom deck 302 and the top deck 304 can be modified so as to meet the requirements of ISO 8611 static test methods 8.4 (Fork Lifting Tests), 8.6 (Stacking Test) and 8.7 (Dead-Weight Bending Test). As discussed herein, the structural components of the flame retardant pallet can be formed from a polymeric composite material of the present disclosure. The polymeric composite material has a specific strength of at least 55 kN·m/kg and a specific stiffness of at least 3500 kN·m/kg as tested according to ASTM D638-10 (tensile strength) and D790-00 (flex modulus), which were each divided by the specific gravity (determined through ASTM D792-08) to arrive at the given values. This information, used in conjunction a Finite Element Analysis software package, such as SOLIDWORKS™ 2011 Premium SIM software, allows for a number of possible cross-beam 340 designs for each of the bottom deck 302 and the top deck 304 that can be used in meeting the requirements of ISO 8611 static test methods 8.4 (Fork Lifting Tests), 8.6 (Stacking Test) and 8.7 (Dead-Weight Bending Test), among others.

As illustrated in FIG. 3, the design of the cross-beans 340 for the bottom deck 302 can be different than the top deck 304. This can result in each of the bottom deck 302 and the top deck 304 having different weights relative to each other. The weight of the fire resistant pallet 300, however, can be 60 pounds (27.2 kg) or less. For example, the fire resistant pallet can have a weight depending upon its weight capacity of 30 pounds (13.6 kg) for a pallet having a 1500 pound (680 kg) load capacity to 35 pounds (15.9 kg) for a pallet having a 2800 pound (1270 kg) load capacity. Preferably, the weight of the fire resistant pallet 300 is from 30 pounds (13.6 kg) to 60 pounds (27.2 kg). Other preferable ranges for weight of the fire resistant pallet 300 include from 35 pounds (15.9 kg) to 60 pounds (27.2 kg).

As discussed herein, in attempting to achieve ISO 8611 static test methods 8.4 (Fork Lifting Tests), 8.6 (Stacking Test) and 8.7 (Dead-Weight Bending Test) the various dimensions of the structural components of the flame retardant pallet can each be individually adjusted and modified depending upon the specific strength and specific stiffness of the polymeric composite material used to form the structural components. As discussed herein, the polymeric composite material used to form the structural components should achieve a specific strength of at least 55 kN-m/kg and a specific stiffness of at least 3500 kN-m/kg as tested according to ASTM 1)638-10 (tensile strength) and D790-00 (flex modulus), which were each divided by the specific gravity (determined through ASTM D792-08) to arrive at the given values. As such, the dimensions and configurations of structural components of the flame retardant pallet can be adjusted and/or modified in trying to achieve the standards of ISO 8611 static test methods 8.4 (Fork Lifting Tests), 8.6 (Stacking Test) and 8.7 (Dead-Weight Bending Test), while also achieving a weight of 27.2 kg or less, preferably from 15.9 kg to 27.2 kg.

For example, the flame retardant pallet illustrated in FIGS. 1 and 3 can be formed from the polymeric composite material of the present disclosure (having a density of 0.053 pounds per cubic inch) in which the bottom deck is formed with 11.26 pounds (5.11 kg) of the polymeric composite material, the top deck is formed with 20.16 pounds (9.14 kg) of the polymeric composite material and the deck spacer 106 is formed with 0.65 pounds (0.29 kg) of the polymeric composite material and each of the walls has a nominal thickness of approximately 3 mm. This allows for a flame retardant pallet 100 of approximately 38 pounds (17.24 kg) with the following dimensions: a width of 48 inches (1219 mm), a length of 40 inches (1016 mm), the deck spacer 106 having an outer diameter of 6 inches (15.25 cm), a length of 5.375 inches (13.65 cm); the cross beams 132 and the wall defining the socket 112 having a height of 1 inch (2.54 cm); and the skin 140 having a thickness of approximately 3 mm. This is, of course, only one embodiment of many that are possible.

It is also appreciated that there can be changes in the nominal wall thickness for one or more of the structural components (e.g., from 3 mm to any one of 3.1 mm, 3.2 mm, 3.3 mm, 3.4 mm, 3.5 mm, 3.6 mm, 3.7 mm, 3.8 mm, 3.9 mm 4.0 mm, 4.1 mm, 4.2 mm, 4.3 mm, 4.4 mm, 4.5 mm, 4.6 mm, 4.7 mm, 4.8 mm, 4.9 mm, 5.0 mm, etc.), which can result in changes to, among other things, the weight and the strength of the flame retardant pallet. Another advantage of the fire resistant pallet of the present disclosure is that because the structural components of the flame retardant pallet are each formed separately and releasebly joined together using the mechanical fastener, it is possible to rebuild the flame retardant pallet. Specifically, the structural components of the pallet of the present disclosure can be replaced, as needed, to allow the pallet to be rebuilt or repaired as components become damaged. It is also possible to dismantle the flame retardant pallet for cleaning. It is also possible that the structural components can be transported in a kit form before assembly, thus saving space and transport costs.

For the various embodiments, while the flame retardant pallet 100 may include a mechanical fastener 108 that can be made of metal and/or a metal alloy, the remainder of the flame retardant pallet 100 (e.g., the bottom deck, the top deck and the deck spacers) is made from the polymeric composite material provided herein. In other words, besides the possible use of a metal and/or metal alloy for the mechanical fastener 108, the flame retardant pallet 100 does not necessarily include or require metal and/or metal alloy reinforcement members that form a frame and/or support structure for the flame retardant pallet 100. Other embodiments of the flame retardant pallet are possible however.

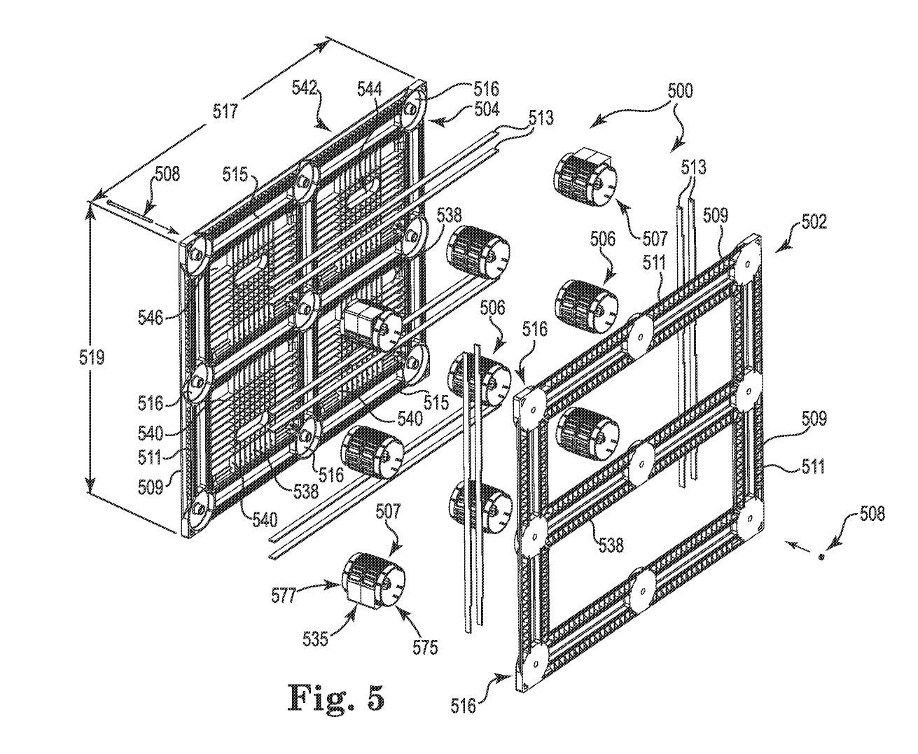

FIG. 5 provides such an additional embodiment of the flame retardant pallet 500 according to the present disclosure. FIG. 5 shows the flame retardant pallet 500 in an exploded view. The flame retardant pallet 500 includes a bottom deck 502, a top deck 504, a deck spacer 506 and a corner deck spacer 507. As illustrated, the flame retardant pallet 500 includes five of the deck spacers 506 and four of the corner deck spacers 507. The structural components (e.g., the bottom deck, the top deck, the deck spacer and the corner deck spacer) of the flame retardant pallet 500 can be assembled and disassembled (e.g., reversibly assembled), as discussed herein.

The bottom deck 502 and the top deck 504 can each include an outer peripheral side rail 509 and rib structures 511 that extend from the outer peripheral side rail 509. The outer peripheral side rail 509 and rib structures 511 are molded with the other components of either the bottom deck 502 or the top deck 504. The outer peripheral side rail 509 and the rib structures 511 help to provide impact resistance to the outer perimeter of the bottom deck 502 and the top deck 504.

The flame retardant pallet 500 further includes a reinforcement member 513. The reinforcement member 513 is a structural component that is added to or integrated into the bottom deck 502 and/or the top deck 504 of the flame retardant pallet 500. The reinforcement member 513 can be used in conjunction with the frame structure 538 of the bottom deck 502 and/or the top deck 504. In addition to the cross beams 540, the reinforcement member 513 can help to distribute a load from items placed on an upper surface 542 of the top deck 504 and transfer that load through the deck spacers 506 and the corner deck spacers 507 to the bottom deck 502. The upper surface 542 of the top deck 504 can also define openings 544 through the top deck 504. The bottom deck 502 and the top deck 504 also include a skin 546 between the cross beams 540, as discussed herein.

The reinforcement member 513 is positioned in a reinforcement channel 515 located in both the top deck 504 and the bottom deck 502. Portions of the reinforcement member 513 extend into the socket 516 of both the top deck 504 and the bottom deck 502. As illustrated, the reinforcement member 513 has an elongate body that extends at least partially across the length 517 and/or at least partially across the width 519 of the top deck 504 and/or the bottom deck 502. The elongate body of the reinforcement member 513 can be one contiguous structure (e.g., formed as one contiguous structure).

The use of the reinforcement member 513 may help to provide the flame retardant pallet 500 with creep resistance, heat resistance, impact resistance and overall durability. The use of the reinforcement member 513 may also help to compensate for processing imperfections that can reduce properties in the polymeric composite material (e.g., “weld line” issues, cross-fiber property reductions and/or porosity).

The width and length of the reinforcement channel 515 can be sized to receive and hold the reinforcement member 513. For the embodiments, the reinforcement member 513 can be positioned in the reinforcement channel 515 so that the reinforcement member 513 does not extend above the upper surface of the upper deck 504. Similarly, the reinforcement member 513 does not extend below the lower surface of the lower deck 502 when positioned in the reinforcement channel 515.

The reinforcement member 513 can be held in the reinforcement channel 515 by a number of techniques. For example, reinforcement member 513 can be held in the reinforcement channel 515 by an interference fit (also known as a press fit or a friction fit). For this embodiment, dimensions of the reinforcement member 513 and/or the reinforcement channel 515 are configured so that sufficient pressure is required to insert the reinforcement member 513 into the reinforcement channel 515, where one or both of the reinforcement member 513 and the reinforcement channel 515 are physically deformed during the insertion process, thereby joining the reinforcement member 513 and the reinforcement channel 515. Mechanical fasteners can also be used to join the reinforcement member 513 and the reinforcement channel 515. Chemical welding can also be used by itself or in conjunction with another process for joining the reinforcement member 513 and the reinforcement channel 515. Such chemical welding processes can include the use of two part epoxy systems, cyanoacrylates, and/or polyurethanes.

Preferably, however, the reinforcement channel 515 is formed in situ around the reinforcement member 513 (e.g., it is “molded in”) during the molding process of either the top deck 504 and/or the bottom deck 502. In this embodiment, one or more of the reinforcement member 513 is inserted at a predetermined location in a mold shaped and used in forming either the top deck 504 or the bottom deck 502. The reinforcement member 513 can located in and held in place within the mold through the use of spacers or through the use of a tapered channel in the mold. The polymeric composite material is then formed around each of the reinforcement member 513 during the molding process. This “molding-in” process at least partially encapsulates the reinforcement member 513 in the polymeric composite material of the top deck 504 and/or the bottom deck 502. The molding process is discussed more fully herein.

The reinforcement member 513 can be formed from a material selected from the group consisting of a metal, a metal alloy, a polymeric material, a reinforced polymeric material, a ceramic material or a combination thereof. Examples of metals include, but are not limited to, aluminum among others. Suitable examples of aluminum include, but are not limited to, 6061 T-6 (Specific Strength [(MPa/(g/cm³)]=88 and Specific Modulus [(MPa/(g/cm³)]=25,536). Examples of metal alloys include, but are not limited to, steel, stainless steel, aluminum alloys, titanium, and/or nickel alloys. An example of a combination of the materials for the reinforcement member 513 includes a multilayer structure of a pultruded continuous filament thermoset/glass composite, aluminum, and a continuous filament laminated thermoplastic.

Examples of reinforced polymeric materials include, but are not limited to, continuous fiber thermoset based composite materials and continuous fiber thermoplastic based composite materials. The continuous fiber thermoset based composite material can include reinforcement fibers available in a continuous strand as discussed herein (e.g., carbon fiber, aramid, glass). Preferably, the continuous strand is fiberglass, specifically E-glass of having filament diameters and sizings that match the resin. The resin can be a thermosetting resin, such as polyester, vinyl ester, epoxies, and/or phenolic. Preferably, the thermosetting resin is polyester. For the reinforced polymeric materials the specific strength in the fiber direction can be at least 350 MPa/(g/cm³) to 500 MPa/(g/cm³). The specific strength in the fiber direction can also be from 100 MPa/(g/cm³) to 500 MPa/(g/cm³). The specific modulus in the fiber direction can be at least 20,000 MPa/(g/cm³) to 35,000 MPa/(g/cm³). The specific modulus in the fiber direction can also be from 10,000 MPa/(g/cm³) to 35,000 MPa/(g/cm³).

The continuous fiber thermoplastic based composite material can include reinforcement fibers available in a continuous strand as discussed herein (e.g., carbon fiber, aramid, glass). Preferably, the continuous strand is fiberglass, specifically E-glass of having filament diameters and sizings that match the resin. The thermoplastic can be selected from those discussed herein, such as nylon and polyolefins like polypropylene and polyethylene, polyurethane, etc. Preferably, the thermoplastic is polypropylene. For the reinforced polymeric materials the specific strength in the fiber direction can be at least 150 MPa/(g/cm³) to 500 MPa/(g/cm³). The specific strength in the fiber direction can also be from 100 MPa/(g/cm³) to 500 MPa/(g/cm³). The specific modulus in the fiber direction can be at least 8,000 MPa/(g/cm³) to 35,000 MPa/(g/cm³). The specific modulus in the fiber direction can also be from 5,000 MPa/(g/cm³) to 35,000 MPa/(g/cm³).

The reinforcement member 513 can have a cross-sectional shape selected from one or more of a circular shape, an oval shape, polygonal shape (e.g, rectangular, triangular, square, etc.), a C-channel shape, an L-channel shape and/or an I-beam shape. It is possible to have a reinforcement member 513 with two or more of these cross-sectional shapes (e.g., first portion(s) that have a circular shape and second portion(s) that have an oval shape). As illustrated in FIG. 5, the reinforcement member 513 has a rectangular cross section. In one embodiment, the rectangular cross section of the reinforcement member 513 is 0.125 inches (3.175 mm) by 0.875 inches (22.225 mm).

The number, relative position and dimensions of the cross-beams 540 and the reinforcement members 513 on both the bottom deck 502 and the top deck 504 can be modified so as to meet the requirements of ISO 8611 static test methods 8.4 (Fork Lifting Tests), 8.6 (Stacking Test) and 8.7 (Dead-Weight Bending Test). As discussed herein, the structural components of the flame retardant pallet can be formed from a polymeric composite material of the present disclosure. A Finite Element Analysis software package, such as SOLIDWORKS™ 2011 Premium SIM software, allows for a number of possible cross-beam 540 and reinforcement members 513 designs for each of the bottom deck 502 and the top deck 504 that can be used in meeting the requirements of ISO 8611 static test methods 8.4 (Fork Lifting Tests), 8.6 (Stacking Test) and 8.7 (Dead-Weight Bending Test), among others.

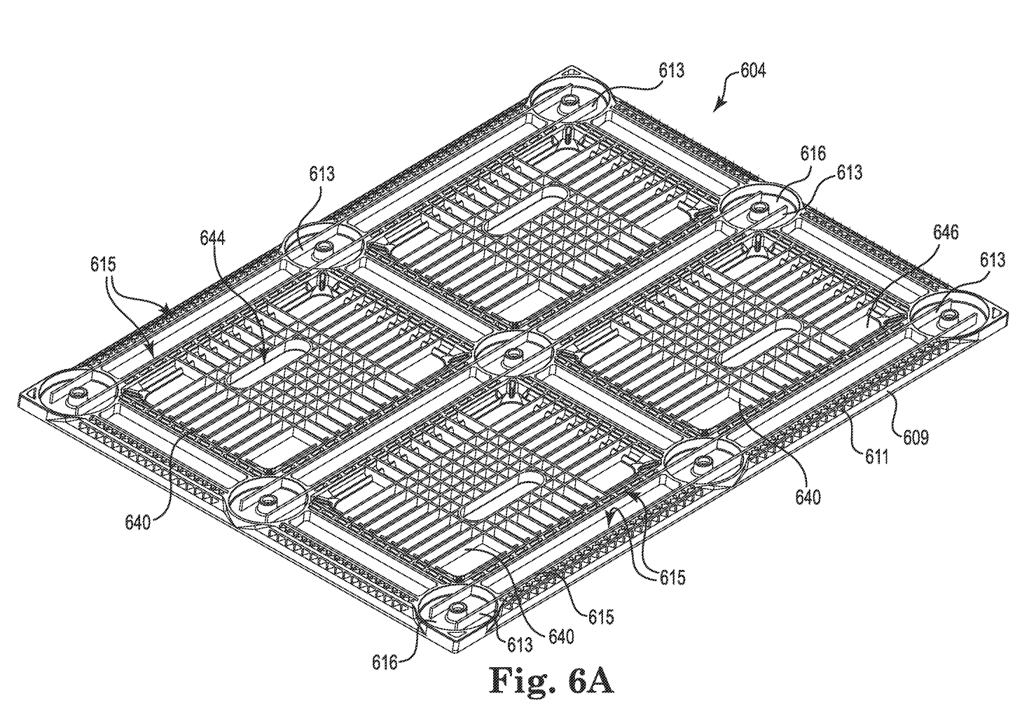

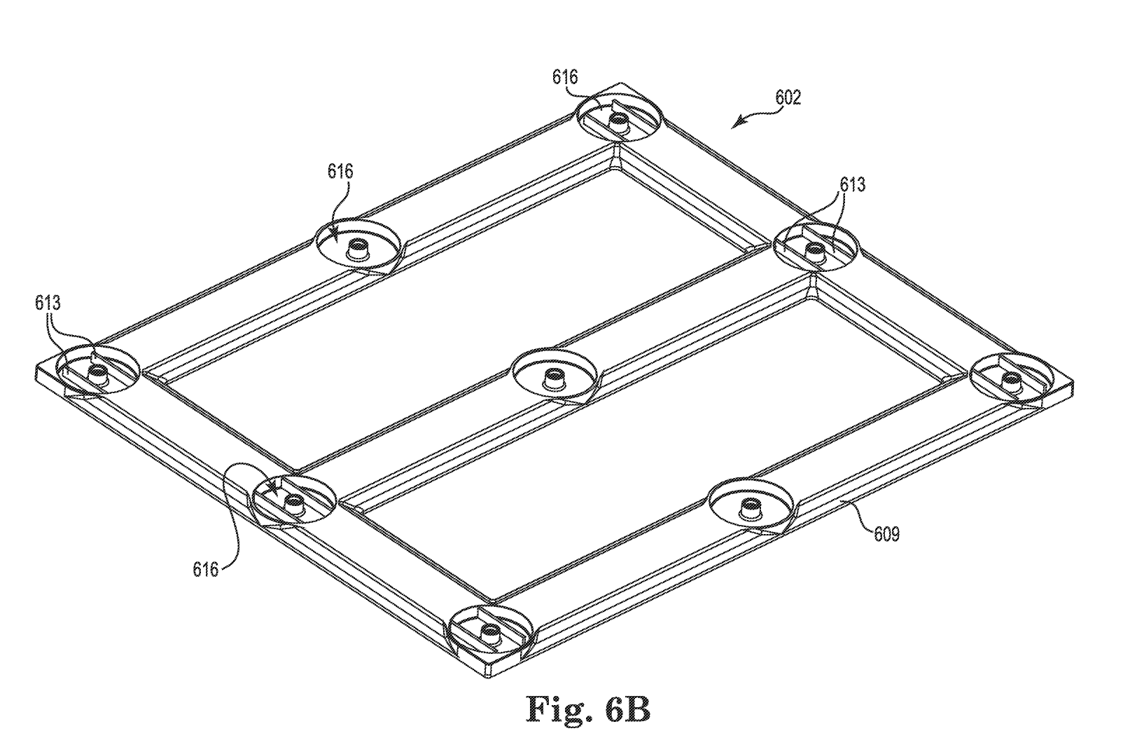

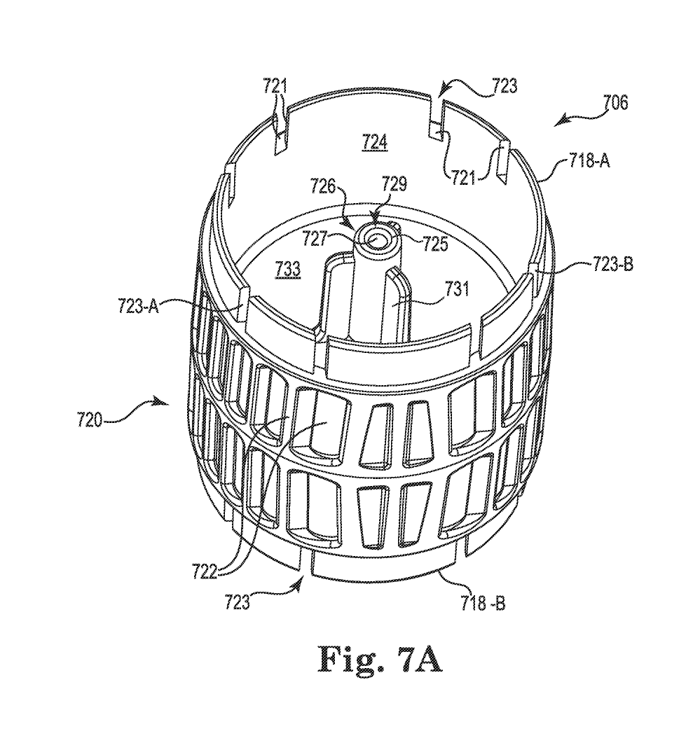

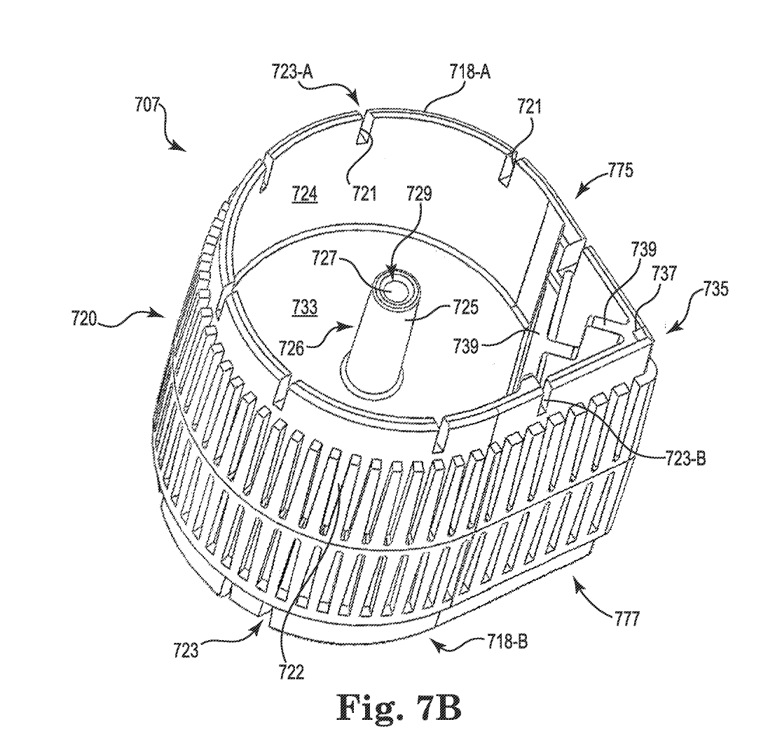

Referring now to FIGS. 6A and 6B, there is shown the underside of the top deck 604 (FIG. 6A) and the topside of the bottom deck 602 (FIG. 6B) of the flame retardant pallet, as seen in FIG. 5. As illustrated, the reinforcement member 613 is shown positioned in the reinforcement channel 615, where a portion of the reinforcement member 613 extends through the socket 616. As illustrated in FIG. 5, and as will be illustrated in FIGS. 7A and 7B herein, the deck spacer 706 and the corner deck spacer 707 have surfaces that define an indentation through which the reinforcement member (element number “13”) can pass. This configuration also allows the deck spacer 706 and the corner deck spacer 707 once seated in the sockets (element number “16”) to maintain their positions within the sockets relative the top deck 604 and the bottom deck 602. For example, the deck spacer 706 and the corner deck spacer 707 once seated in the sockets of the top deck and/or the bottom deck will be prevented from rotating.

Referring now to FIGS. 7A and 7B, there is shown an embodiment of the deck spacer 706 (FIG. 7A) and the corner deck spacer 707 (FIG. 7B). As illustrated, the deck spacer 706 (FIG. 7A) and the corner deck spacer 707 (FIG. 7B) each have a first end 718-A and a second end 718-B that include a surface 721 that defines the indentation 723 through which the reinforcement member can pass. The deck spacer 706 and the corner deck spacer 707 include a wall 720 having an outer surface 722 and an inner surface 724. The deck spacer 706 and the corner deck spacer 707 also include the fastener guide 726 having a guide body 725 that allows the mechanical fastener (e.g., 508) to pass across either of the deck spacer 706 and the corner deck spacer 707.

As illustrated, the guide body 725 of the fastener guide 726 has a surface 727 that defines an opening 729 through which at least a portion of the mechanical fastener (e.g., a shaft of a bolt) can pass through either the deck spacer 706 or the corner deck spacer 707. The guide body 725 can further include a buttress 731 that extends from the guide body 725 to a lateral support member 733. The lateral support member 733 extends from the inner surface 724 of either the deck spacer 706 or the corner deck spacer 707 to the guide body 725 and the buttress 731. The wall 720, the guide body 725, the buttress 731 and the lateral support member 733 can be formed from the polymeric composite material of the present disclosure. This can be done in a process using a single mold that defines the different parts of the deck spacer 706 and/or the corner deck spacer 707 discussed herein.

In addition, the surfaces 721 that define the indentation 723 through which the reinforcement member can pass are positioned relative to each other in such a way that the reinforcement member passes to the side of the guide body 725 and the buttress 731 structures (when present). As illustrated, the surfaces 721 of two of the indentation 723 can be parallel to each other so that the reinforcement member passes through the two indentations 723 while staying to the side of the guide body 725 and the buttress 731 structures (when present). Indentations 723-A and 723-B in FIGS. 7A and 7B are examples of two such indentations 723.

FIG. 7A provides an illustration of the deck spacer 706 in which the outer surface 722 has a generally circular cross-sectional shape, where the cross section is taken perpendicular to the surface 727 that defines the opening 729 of the guide body 725. This circular cross sectional shape allows the indentations 723 of the deck spacer 706 to be positioned in one of a number of positions relative the reinforcement members that may be passing through the socket of the top deck (e.g., FIG. 6A) and/or the bottom deck (e.g., FIG. 6B) of the flame retardant pallet.

FIG. 7B provides an illustration of the corner deck spacer 707 in which the outer surface 722 has a generally circular cross-sectional shape in which a portion of the outer surface 722 meets at a corner 735. As illustrated, the corner 735 of outer surface 722 has an angle that is approximately 90 degrees 737. The corner deck spacer 707 also has a first end 775 and a second end 777 where the outer surface 722 of each end 775 and 777 has a generally circular cross-sectional shape with the portion of the outer surface 722 meets at a corner 735. The socket of the upper deck and/or lower deck has the corresponding shape that can receive and seat the outer surface 722 of the first end 775 and the second end 777 of the corner deck spacer 707.

The corner 735 of the corner deck spacer 706 can also provide further reinforcement to the peripheral surface of the flame retardant pallet. As illustrated, the corner 735 can include interior beams 739 that can help to transfer and distribute the force of an impact on the corner 735 to the circular portion of the wall 720.

It is noted that this embodiment of the corner deck spacer 706 differs from the corner deck spacer 507 shown in FIG. 5. As illustrated in FIG. 5, the corner deck spacer 507 has a first end 575 and a second end 577 each having an outer surface with a generally circular cross-sectional shape that can be inserted into the socket 516 of the upper deck 504 and lower deck 502 (the surface defining the sockets 516 has the corresponding shape that can receive and seat the outer surface of the corner deck spacer 507). As illustrated, the corner deck spacer 507 also includes the corner 535 of the outer surface that meets at the approximately 90 degree angle.

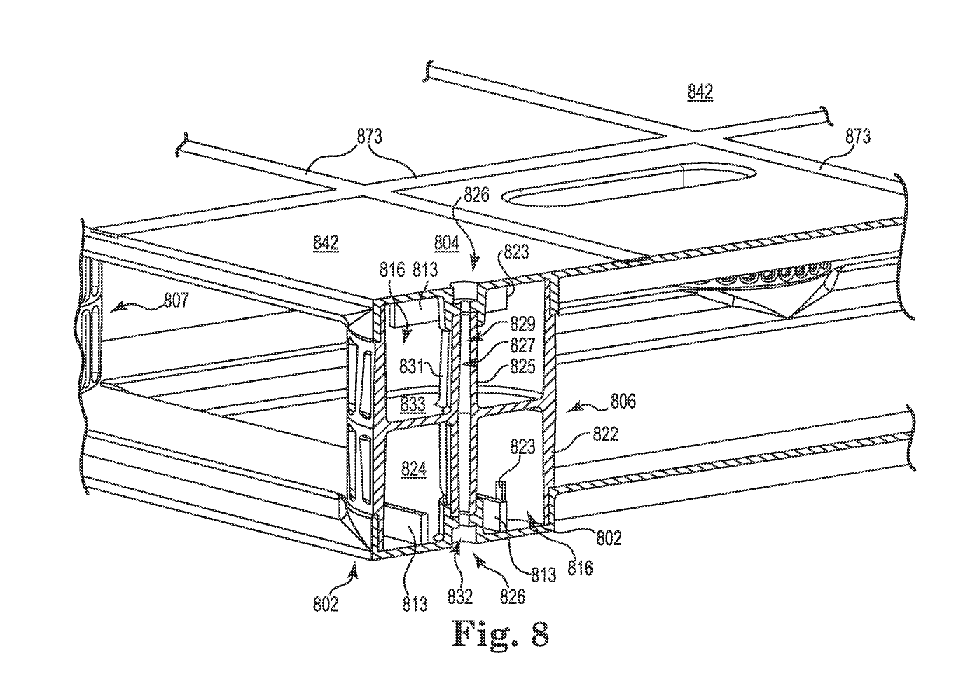

FIG. 8 shows a cross-sectional view of a flame retardant pallet 800 according to an embodiment of the present disclosure. As illustrated, the flame retardant pallet 800 includes the bottom deck 802, the top deck 804 and the deck spacer 806 shown in cross-section. Each of the bottom deck 802 and the top deck 804 include the fastener guide 826, as discussed herein. The deck spacer 806 seats in the socket 816 with the reinforcement member 813 passing through the indentation 823 and being adjacent to the guide body 823. The guide body 825 includes the surface 827 that defines the opening 829 which in conjunction with the fastener guide 826 of the bottom deck 802 and the top deck 804 provide the opening 832 through which at least a portion of the mechanical fastener can pass.

FIG. 8 also shows an embodiment where the top deck 804 of the flame retardant pallet 800 is provided with a skid resistant surface 873. The skid resistant surface 873 is in top deck 804, where an upper surface of the skid resistant surface 873 is level with or extends slightly above the upper surface 842 of the top deck 804. The skid resistant surface 873 provides a surface that can grip items set on the upper surface 842 of the top deck 804. The skid resistant surface 873 can be a polymer based material, such as a thermoset or a thermoplastic. Examples of the thermoset include, but are not limited to, an epoxy or a urethane, or rubbers such as Styrene Butidiene Rubber (SBR). Examples of thermoplastics include, but are not limited to, ionomers, thermoplastic polyolefin blends (TPO's), and thermopolastic elastomers and vulcanates (TPE's, TPV's).

The skid resistant surface 873 can also be formed of a thermoplastic elastomer or a thermoset elastomer. These elastomers include both a polymer (and/or a copolymer) component that provides thermoplastic properties and a rubber or elastomeric component that provides elastomeric properties. Examples of suitable thermoplastic elastomers and/or thermoset elastomers include styrenic-block copolymers, polyolefin blends, elastomeric alloys, thermoplastic polyurethanes, thermoplastic copolyesters, and thermoplastic polyamides.

The skid resistant surface 873 can be formed by an injection molding process. In forming the top deck 804, the skid resistant surface 873 can be inserted into the mold for the top deck 804 in such a way that at least a portion of the skid resistant surface 873 will be exposed at or above the upper surface 842 of the top deck 804 after the molding process. In addition to the polymer based material the skid resistant surface 873 can also be textured through the use of one or more of silca sand, polypropylene beads and/or aluminum oxide, among other materials. As illustrated, the skid resistant surface 873 can have a predefined pattern (e.g., cross-hatch) that can be configured to best accommodate and hold the type of articles placed on the upper surface 842 of the top deck 804.

The flame retardant pallet of the present disclosure can also include a radio-frequency identification (RFID) chip for the purpose of automatic identification and tracking of the flame retardant pallet.

The flame retardant pallet can also be configured to allow any one of a pallet jack, a fork lift, a front loader or other jacking device to functionally engage the flame retardant pallet from any one of the four sides of the pallet (e.g., a “four-way” pallet). In this way the flame retardant pallet can be compliant with the Grocery Manufacturers of America (GMA) guidelines. The pallet of the present disclosure can also be configured to have any one of the six pallet dimensions sanctioned by the International Organization for Standardization (ISO) under the ISO Standard 6780. The pallet of the present disclosure can also be formed into either a “stringer” pallet and/or a “block” pallet.

As discussed herein, at least one structural component of the flame retardant pallet of the present disclosure can be formed from the polymeric composite material. As discussed herein, the at least one structural component can be selected from the group consisting of a bottom deck, a top deck, a deck spacer and combinations thereof, all as provided herein.

The polymeric composite material of the present disclosure is formed from a polyolefin, a long glass fiber reinforcement, coupling agent and a flame retardant. Specifically, the polymeric composite material includes 45 weight percent (wt. %) to 78 wt. % of the polyolefin, 20 wt. % to 50 wt. % of a long glass fiber reinforcement, 0.5 wt. % to 3 wt. % of the coupling agent, which can react to couple the long glass fiber reinforcement to the polyolefin; and up to 25 wt. % of a flame retardant. The polymeric composite material can also include 45 weight percent (wt. %) to 78 wt. % of the polyolefin, 20 wt. % to 50 wt. % of a long glass fiber reinforcement, 0.5 wt. % to 3 wt. % of the coupling agent, which can react to couple the long glass fiber reinforcement to the polyolefin; and greater than 0 wt. % to 25 wt. % of a flame retardant. The wt. % values of the polymeric composite material are based on a total weight of the polymeric composite material. The weight percent of the polyolefin, the long glass fiber reinforcement, the coupling agent and the flame retardant used in forming the polymeric composite material total to a value of 100 wt. %. The polymeric composite material used to form the structural component has a specific strength of at least 55 kN·m/kg and a specific stiffness of at least 3500 kN·m/kg as tested according to ASTM D638-10 (tensile strength) and D)790-00 (flex modulus), which were each divided by the specific gravity (determined through ASTM D792-08) to arrive at the given values. The polymeric composite material can also include 0.1 to less than 8 wt. % of the flame retardant.

In one embodiment, the polymeric composite material includes 45 wt. % to 57.4 wt. % of the polyolefin; 30 wt. % to 50 wt. % of the long glass fiber reinforcement; 0.5 wt. % to 3 wt. % of the coupling agent; and 0 wt. % of the flame retardant. In an additional embodiment, the polymeric composite material includes 53 wt. % to 69.6 wt. % of the polyolefin; 20 wt. % to 30 wt. % of the long glass fiber reinforcement; 0.5 wt. % to 1.5 wt. % of the coupling agent; and 0.1 wt. % to 7.9 wt. % of the flame retardant. In a further embodiment, the polymeric composite material includes 52 wt. % to 59 wt. % of the polyolefin; 20 wt. % to 30 wt. % of the long glass fiber reinforcement; 1.0 wt. % to 3 wt. % of the coupling agent; and 8 wt. % to 15 wt. % of the flame retardant. Other values for the polyolefin, long glass fiber reinforcement, coupling agent and flame retardant are also possible.

It is also possible that the polymeric composite material of the present disclosure can have 0 weight percent of the flame retardant, such that a flame retardant pallet can include at least one structural component formed from a polymeric composite material having 35 wt. % to 78 wt. % of a polyolefin, as discussed herein, 20 wt. % to 50 wt. % of a long glass fiber reinforcement, as discussed herein, and 0.5 wt. % to 3 wt. % of a coupling agent coupling the long glass fiber reinforcement to the polyolefin, as discussed herein, where the wt. % values of the polymeric composite material are based on a total weight of the polymeric composite material and total to a value of 100 wt. %, and the polymeric composite material used to form the structural component has a specific strength of at least 55 kN-m/kg and a specific stiffness of at least 3500 kN·m/kg as tested according to ASTM D638-10 (tensile strength) and D790-00 (flex modulus), which were each divided by the specific gravity (determined through ASTM D792-08) to arrive at the given values.

Examples of suitable polyolefins for the present disclosure include, but are not limited to, polypropylene, polyethylene, polybutylene and a combination thereof. The polyolefins for the present disclosure can also be copolymers (e.g., heterophasic copolymers, random copolymers, block-copolymers) formed with propylene and ethylene monomers. It is also possible to include a plastomer with the polyolefin or the copolymer, where examples of such plastomers include, but are not limited to butene or octene. It is also possible to use polyethylene terephthalate (e.g., textile grades in particular). Different polyolefins may be used for various structural components. Blends of polyolefins with other compatible thermoplastics or with elastomeric tougheners such as elastomeric polymers of styrene, butadiene, alkyl acrylates, and the like may also be useful.

Preferably, the polyolefin of the present disclosure is polypropylene. Generally, the polypropylene can have a melt flow index from 12 to 140 as measured according to ASTM D1238. More specifically, the polypropylene can have a melt flow index from 28 to 38 as measured according to ASTM D1238. Examples of such polypropylene include, but are not limited to, those from INEOS (England), such as Ineos H38G-02, those from Lyondell Bassell, those from Braskem, those from Total Petrochemicals and those from Exxon Mobile, among others.

As used herein, long glass fiber reinforcement includes fiberglass that has a mean average length from 0.5 cm to 2.5 cm. It is also appreciated that the long glass fiber reinforcement could be introduced as a fiberglass roving (e.g., in a direct long fiber thermoplastic process as discussed herein) into the mixing process, whereby the fiberglass roving is chopped, or broken apart, during the mixing process so as to achieve glass fibers having mean average length from 0.5 cm to 2.5 cm. Preferably, the long glass fiber reinforcement has a mean average length of 1.0 cm to 1.5 cm.

For the various embodiments, the long glass fiber reinforcement can have a variety of structural grades. For example, the long glass fiber reinforcement can be an Electrical-grade (E-grade) prechopped fiberglass. Other grades are also possible, such as S-grade or S2-grade among others. Examples of such glass fiber include, but are not limited to, those from Johns Manville, Owens Corning and those from Jushi, among others.

The long glass fiber reinforcement can have an aspect ratio in a range from 150 to 700 (mean average) when added during the compounding of the polymeric composite material. Preferably, the long glass fiber reinforcement can have an aspect ratio in a range of 400 to 700 (mean average) when added during the compounding of the polymeric composite material. In one embodiment, the long glass fiber reinforcement can have an aspect ratio of 700 (mean average) when added during the compounding of the polymeric composite material. It is appreciated that the aspect ratio of the long glass fiber reinforcement can change (e.g., decrease) during the compounding of the polymeric composite material in the mixer(s) (e.g., the extruder).

It is further appreciated that the long glass fiber may also include a sizing agent (e.g., has a sizing agent on its surface). A variety of sizing agents are possible, where the selection of the sizing agent can be dependent upon the matrix (e.g., polymer matrix) into which the long glass fiber reinforcement will be used. This sizing agent, if present on the long glass fiber, is considered to be different than the coupling agent of the present disclosure. Specifically, regardless of a sizing agent being present on the long glass fiber, or not being present, the present disclosure separately adds the coupling agent to the polymeric composite material of the present disclosure.

As provided herein, the coupling agent is a component of the polymeric composite material that is added separately from the other components used in forming the polymeric composite material. As used herein a coupling agent is a chemical compound added independent of the long glass fiber reinforcement, where the coupling agent is capable of reacting with and covalently joining both the long glass fiber reinforcement and the polyolefin. Preferably, among other suitable coupling agents, the coupling agent is maleic anhydride (Furan-2,5-dione).

Examples of suitable flame retardants for the polymeric composite material include, but are not limited to, mineral based flame retardants such as, but not limited to, magnesium hydroxide, aluminum hydroxide, alumina trihydrate, hydromagnesite, zinc borate, and a combination thereof. Preferably, the flame retardant for the polymeric composite material is magnesium hydroxide. The flame retardant can have a mean average particle size in a range of 3 to 6 μm. Preferably the flame retardant has a mean average particle size of 4.5 μm. Other known flame retardants are also possible (e.g, heat suppression agents and char formers).

In a preferred embodiment of the polymeric composite material used to form the at least one structural component of the flame retardant pallet the polyolefin is polypropylene, the coupling agent is maleic anhydride and the flame retardant is magnesium hydroxide.

The polymeric composite material of the present disclosure can also include a variety of additional additives. For example, the polymeric composite material can include a color additive. Examples of a suitable color additive include a color concentrate in solid form that includes an olefinic carrier base resin and carbon black. Alternatives could be a form of pigmentation that will result in a part appearing black. Dosing of the base material using a liquid or a dry powder delivery system could be considered alternatives to coloring the polymeric composite material.

The polymeric composite material of the present disclosure can also include a filler. Examples of suitable fillers include, but are not limited to, carbon fiber, aramid fiber, natural fiber, talc, calcium carbonate, mica, wollastonite, milled fiberglass, and fiberglass solid spheres, and fiberglass hollow spheres, nepheline syenite and combinations thereof. The use of a filler can replace the fire resistant material additive and achieves fire resistance through pure mass replacement with a non-combustible filler. For example, the polymeric composite material can includes 35 wt. % to 78 wt. % of the polyolefin; 20 wt. % to 30 wt. % of the long glass fiber reinforcement; 0.5 wt. % to 1.5 wt. % of the coupling agent; 0 wt. % of the flame retardant and a filler (e.g., nepheline syenite) in an amount greater than 0 wt. % up to 40 wt. %, where wt. % values are based on a total weight of the polymeric composite material, and where the weight percents of the polyolefin, the long glass fiber reinforcement, the coupling agent, the flame retardant, and the filler used in forming the polymeric composite material total to a value of 100 wt. %.

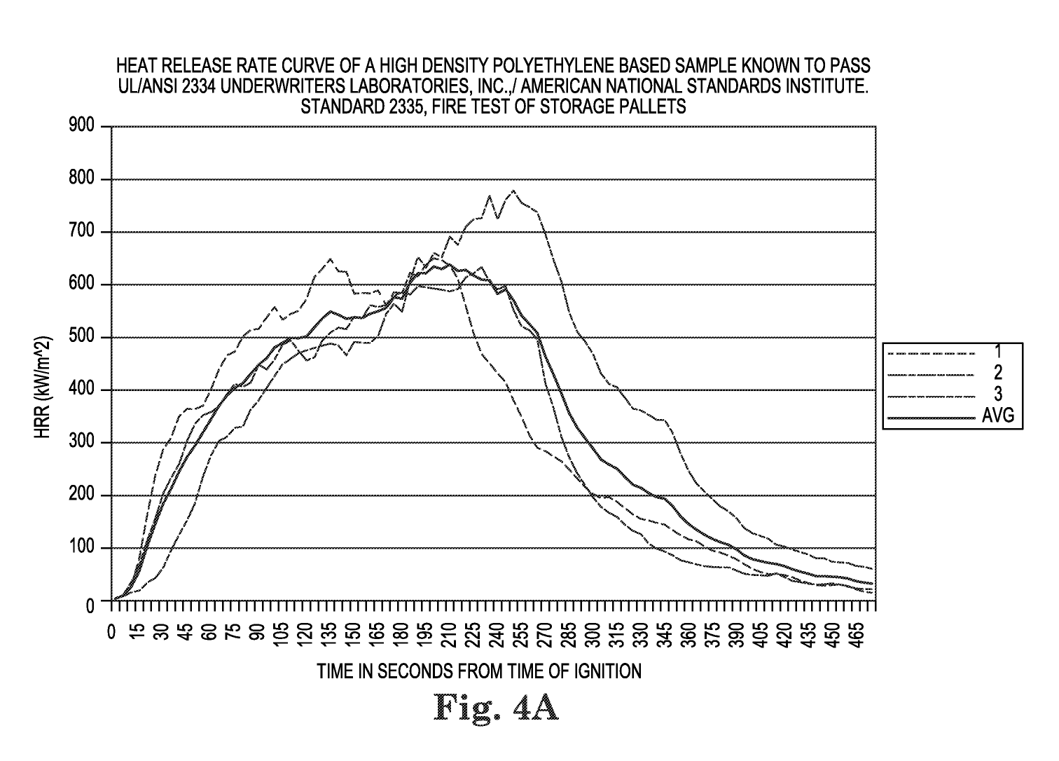

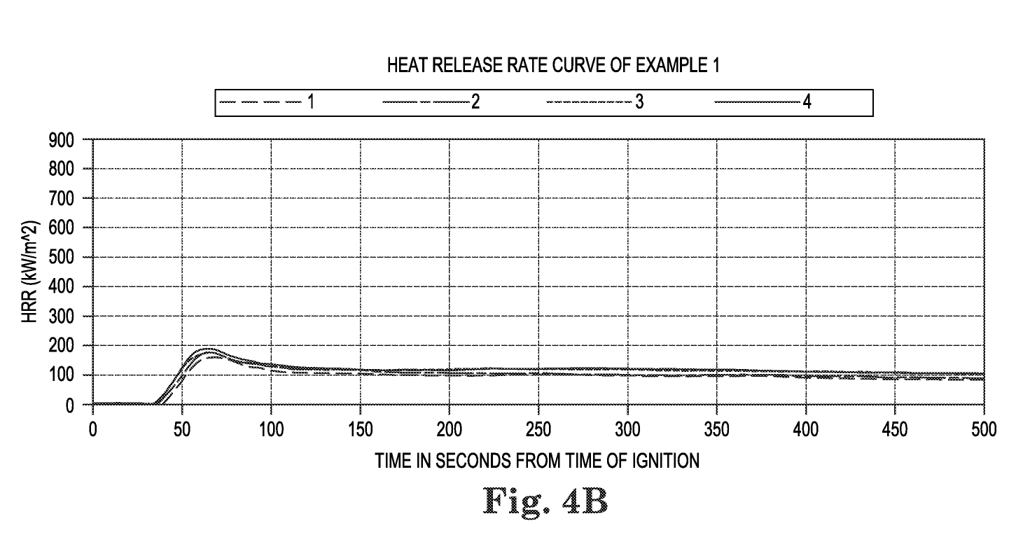

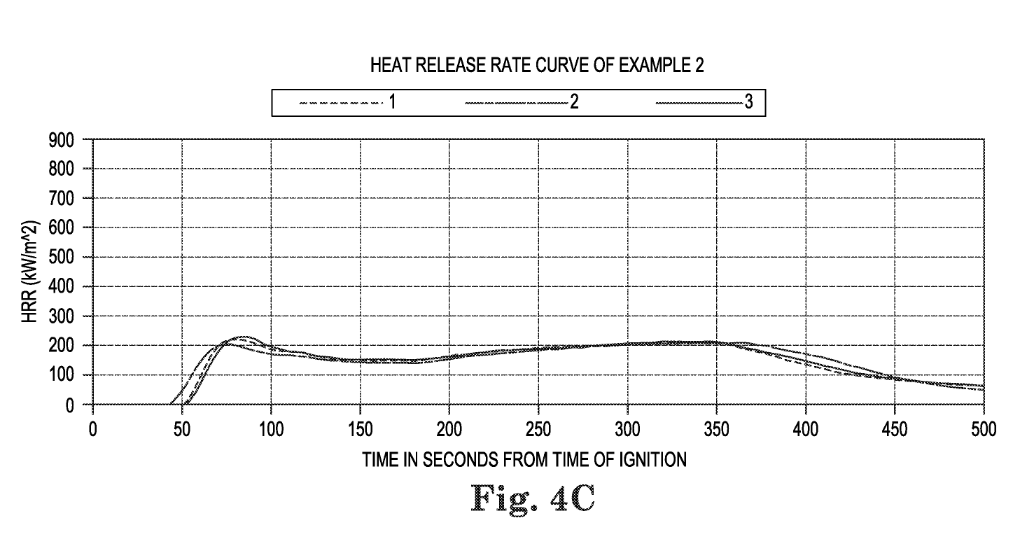

The polymeric composite material of the present disclosure is believed to have sufficient fire retardant properties to allow the flame retardant pallet of the present disclosure to meet UL 2335 “Fire Test of Storage Pallets.” This is based on tests conducted on the polymeric composite material according to ASTM E 1354-09, which allow for a rate of heat release to be determined for the polymeric composite material. FIG. 4A shows the change in Heat Release over time of a polymeric material tested using ASTM E 1354 who is known to pass UL2335. Polymeric materials that show significant reduction in both peak heat release rate as well as average heat release properties over time will therefore have a high confidence in being able to pass UL 2335. FIGS. 4B and 4C illustrates the heat release from two Examples of the polymeric composite material provided here (Examples 1 and 2, both discussed in the Examples section provided herein). FIGS. 4B and 4C show the change in Heat Release over time of Examples 1 and 2 being lower than the Heat Release values shown in FIG. 4A.

For the various embodiments, each of the structural components of the flame retardant pallet can be formed from compositionally identical formulations of the polymeric composite material. Alternatively, one or more of the structural components of the flame retardant pallet can be formed from compositionally different formulations of the polymeric composite material.

The polymeric composite material of the present disclosure can be compounded in a mixing process. Examples of suitable devices for the mixing process can include, but are not limited to, screw extruders or a Banbury mixer. Examples of suitable screw extruders include those with a single or a double screw, where the extruder can include, if desired, a breaker plate and corresponding screen pack. A series of two screw extruders can be used in forming the polymeric composite material of the present disclosure. For example a first screw extruder can be used to melt blend the polyolefin, the coupling agent and the flame retardant. The content of the first screw extruder can be introduced into the second screw extruder along with the long glass fiber reinforcement. Examples of such mixing processes are found in U.S. Pat. Nos. 5,165,941 and 5,185,117, both to Hawley, which are incorporated herein in their entirety.

The polymeric composite material discussed herein can be extruded from the mixing process and then molded into at least one of the structural components of the flame retardant pallet from the polymeric composite material. It is also possible to use a direct long fiber thermoplastic process technique in forming and extruding the polymeric composite material of the present disclosure. Molding techniques used in molding at least one of the structural components include, but are not limited to, compression molding, injection molding or transfer molding.

These molding technique can be used to form each of the top deck, the bottom deck and the deck spacers, which can be assembled using the mechanical fasteners, as discussed herein, to form the flame retardant pallet. If necessary, the mechanical fasteners can be removed from the flame retardant pallet to allow any one of the top deck, the bottom deck and/or the deck spacers of the flame retardant pallet to be replaced. The mechanical fasteners can then be used to reassemble the flame retardant pallet.

The above specification, examples and data provide a description of the present disclosure. Since many examples can be made without departing from the spirit and scope of the present disclosure, this specification merely sets forth some of the many possible example configurations and implementations.

### EXAMPLES

The following examples are given to illustrate, but not limit, the scope of this disclosure. The examples provide methods and specific embodiments of the hardener compound and the epoxy system that includes the hardener compound of the present disclosure.

### Materials

Polyolefin: A polypropylene homopolymer (PP, INEOS polyolefins & polymers) of 38 melt flow index (mfi).

Polyethylene terephthalate (PET, Eastman Chemical Company).

Long glass fiber reinforcement: An Electrical grade of chopped fiberglass fiber coated with olefinic and silane sizing, 12 mm (commercially available from Johns Manville).

Coupling agent: A Polypropelene homopolymer with maleic anhydride grafting content of at least 0.45 weight percent (wt. %) based on Fourier transform infrared spectroscopy (FTIR) (commercially available from Addcomp).

Color additive: An olefinic based color masterbatch with a carbon black concentration of at least 10 wt. % based on ASTM E1131-08 Standard Test Method for Compositional Analysis by Thermogravimetry (commercially available from Americhem).

Flame retardant: Magnesium Hydroxide with a 4.5 micrometer median particle size where at least 98.5% Magnesium Hydroxide Mg(OH)₂ (commercially available from Martin Marietta).

Filler: Nepheline Syenite, provided as a naturally occurring, silica deficient, sodium-potassium alumina silicate having a median particle size of 10.8 micrometer (commercially available from Unimin Corporation).

### Test Methods

Test Tensile Strength (MPa) according to ASTM D638-10.

Test Flexural Modulus (MPa) according to ASTM D790-00.

Test Density (g/cc) (specific gravity) according to ASTM D792-08.

Test Heat and Visible Smoke Release Rates for Materials and Products Using an Oxygen Consumption Calorimeter according to ASTM E1354-09: E1354-09.

### EXAMPLES AND COMPARATIVE EXAMPLES

Table 1 provides examples (Ex) of the present disclosure. The percent (%) values given herein are in weight percent (wt. %) based on a total weight of the polymeric composite material. The components are mixed as follows. All ingredients except the fiberglass are gravimetrically blended above the feed throat of a single screw extruder. This extruder melts and mixes all the non-reinforcing components to the mix. This mixture is fed directly into a second single screw extruder that adds the reinforcing fiber. This secondary mixing step ends in an accumulation chamber that keeps the material warm until the molding process calls for it to be extruded and discharged from its holding chamber.

Physical properties of Example (Ex) 1 and Ex 2 are as reported in Table 1, where the test methods for the reported data are provided after Table 1.

TABLE 1

Example

| | 1 | 2 |
|---|---|---|
| Polyolefin: PP-38mfi | 55% | 35% |
| Long glass fiber reinforcement: Fiberglass fiber 12 mm | 20% | 30% |
| Flame retardant: Magnesium Hydroxide | 20% | |
| Coupling agent: Maleic Anhydride grafted Polypropylene | 1.5% | 1.5% |
| Color additive: Polyolefin based Black Color Masterbatch | 3.5% | 3.5% |
| Filler: Nepheline Syenite | | 30% |
| Tensile Strength (MPa) | 60 | 97 |
| Flexural Modulus (MPa) | 5862 | 10392 |
| Density (g/cc) | 1.20 | 1.47 |
| Specific Strength (kN * m/kg) | 50 | 66 |
| Specific Stiffness (kN * m/kg) | 4885 | 7069 |

The following is Tensile (with extensometer) data measured for Ex 1 according to ASTM D638-10.
Instron Corporation Model 5585
Bluehill Ver. 1.7 Automated Materials Testing System
ASTM D638-10 W/EXTENSOMETER
Standard Test Method for Determination of Tensile Properties of Ex 1

| | | |
|---|---|---|
| Interval 1 | 0.10000 | sec |
| Rate 1 | 0.20000 | in/min |

| | |
|---|---|
| Humidity (%) | 53. |
| Temperature (F.) | 71. |

| | | | Tensile | | Tensile | Tensile | | |
|---|---|---|---|---|---|---|---|---|
| | | | extension at | Maximum | strain at | stress at | Young's | |
| | Thickness | Width | Max. Load | Load | Max. Load | Max. Load | Modulus | Molding |
| Ex 1 | (in) | (in) | (in) | (lbf) | (%) | (psi) | (psi) | Number |
| 1 | 0.145 | 0.502 | 0.015 | 670.7 | 1.51 | 9214.8 | 1095868 | A8 |
| 2 | 0.145 | 0.503 | 0.012 | 628.7 | 1.22 | 8620.4 | 1195947 | A13 |
| 3 | 0.145 | 0.502 | 0.013 | 620.3 | 1.34 | 8521.4 | 1055320 | A14 |
| 4 | 0.144 | 0.502 | 0.012 | 599.5 | 1.22 | 8292.6 | 1115159 | A16 |
| 5 | 0.145 | 0.502 | 0.015 | 638.4 | 1.52 | 8770.5 | 992241 | A17 |
| Mean | 0.145 | 0.502 | 0.014 | 631.5 | 1.36 | 8684.0 | 1090907 | |
| St. Dev | 0.000 | 0.000 | 0.001 | 26.212 | 0.147 | 343.835 | 75245.575 | |
| COV | 0.309 | 0.089 | 10.824 | 4.151 | 10.824 | 3.959 | 6.898 | |

The following is Test Flexural Modulus data measured for Ex 1 according to ASTM D790-00.
Instron Corporation Model 5585
Bluehill Ver. 1.7 Automated Materials Testing System
3-POINT FLEX-ASTM D-790-00 Method I
Standard Test Methods for Flexural Properties of
Unreinforced and Reinforced Plastic of Ex 1

| Rate 1 | 0.06246 | in/min |
|---|---|---|
| interval 1 | 0.10000 | sec |
| Support span | 2.34200 | in |
| Full Cell Load Range | 2000 | |
| Temperature | 70 | Deg F. |

| | |
|---|---|
| Humidity | 45% |

| | | | Extension at | Max | Strain at | Stress at | Young's | |
|---|---|---|---|---|---|---|---|---|
| | Width | Thickness | Max Load | Load | Max Load | Max Load | Modulus | Molding |
| Ex 1 | (in) | (in) | (in) | (lbf) | (%) | (psi) | (psi) | Number |
| 1 | 0.501 | 0.146 | 0.109 | 35.7 | 1.73 | 11758.5 | 830062 | A17 |
| 2 | 0.498 | 0.146 | 0.109 | 36.3 | 1.74 | 12010.0 | 862430 | A16 |
| 3 | 0.500 | 0.146 | 0.106 | 36.9 | 1.69 | 12175.4 | 915497 | A13 |
| 4 | 0.501 | 0.147 | 0.113 | 36.0 | 1.82 | 11691.2 | 801799 | A14 |
| 5 | 0.500 | 0.147 | 0.115 | 39.5 | 1.86 | 12840.6 | 840908 | A8 |
| Mean | 0.500 | 0.146 | 0.110 | 36.9 | 1.77 | 12095.1 | 850139 | |
| St. Dev | 0.001 | 0.001 | 0.004 | 1.515 | 0.068 | 459.858 | 42567.216 | |
| COV | 0.245 | 0.374 | 3.518 | 4.106 | 3.871 | 3.802 | 5.007 | |

The following is Tensile (with extensometer) data measured for Ex 2 according to ASTM D638-10.
Instron Corporation Model 5585
Bluehill Ver. 1.7 Automated Materials Testing System
ASTM D638-10 W/EXTENSOMETER
Standard Test Method for Determination of Tensile Properties of Ex 2

| | | |
|---|---|---|
| Interval 1 | 0.10000 | sec |
| Rate 1 | 0.20000 | in/min |

| | |
|---|---|
| Humidity (%) | 53. |
| Temperature (F.) | 71. |

| | | | Tensile | | Tensile | Tensile | | |
|---|---|---|---|---|---|---|---|---|
| | | | extension at | Maximum | strain at | stress at | Young's | |
| | Thickness | Width | Max. Load | Load | Max. Load | Max. Load | Modulus | Molding |
| Ex 2 | (in) | (in) | (in) | (lbf) | (%) | (psi) | (psi) | Number |
| 1 | 0.145 | 0.503 | 0.011 | 1021.2 | 1.09 | 14001.8 | 2040484 | H8 Broke In Grip |
| 2 | 0.147 | 0.503 | 0.012 | 1052.7 | 1.20 | 14236.7 | 2056421 | H7 Broke In Grip |
| 3 | 0.147 | 0.504 | 0.011 | 1027.3 | 1.11 | 13866.1 | 2011728 | H6 |
| 4 | 0.147 | 0.506 | 0.014 | 1051.9 | 1.40 | 14141.5 | 1744950 | H5 |
| 5 | 0.148 | 0.503 | 0.015 | 1025.8 | 1.49 | 13780.1 | 1716586 | H4 |
| Mean | 0.147 | 0.504 | 0.013 | 1035.8 | 1.26 | 14005.2 | 1914034 | |
| St. Dev | 0.001 | 0.001 | 0.002 | 15.219 | 0.178 | 188.518 | 168361.539 | |
| COV | 0.746 | 0.259 | 14.160 | 1.469 | 14.160 | 1.346 | 8.796 | |

The following is Test Flexural Modulus data measured for Ex 2 according to ASTM D790-00.
Instron Corporation Model 5585
Bluehill Ver. 1.7 Automated Materials Testing System
3-POINT FLEX-ASTM D-790-00 Method 1
Standard Test Methods for Flexural Properties of
Unreinforced and Reinforced Plastic of Ex 2

| Rate 1 | 0.06298 | in/min |
|---|---|---|
| Interval 1 | 0.10000 | sec |
| Support span | 2.36200 | in |
| Full Cell Load Range | 2000 | |
| Temperature | 70 | Deg F. |

| | |
|---|---|
| Humidity | 45% |

| | | | Extension at | Max | Strain at | Stress at | Young's | |
|---|---|---|---|---|---|---|---|---|
| | Width | Thickness | Max Load | load | Max Load | Max Load | Modulus | Molding |
| Ex 2 | (in) | (in) | (in) | (lbf) | (%) | (psi) | (psi) | Number |
| 1 | 0.500 | 0.149 | 0.122 | 64.5 | 1.96 | 20600.3 | 1377090 | H5 |
| 2 | 0.499 | 0.147 | 0.115 | 67.0 | 1.82 | 22013.7 | 1576687 | H6 |
| 3 | 0.499 | 0.147 | 0.107 | 64.0 | 1.69 | 21044.9 | 1579861 | H7 |
| 4 | 0.499 | 0.148 | 0.119 | 67.7 | 1.89 | 21947.7 | 1612909 | H8 |
| 5 | 0.502 | 0.147 | 0.122 | 60.3 | 1.93 | 19682.9 | 1389616 | H4 |
| Mean | 0.500 | 0.148 | 0.117 | 64.7 | 1.86 | 21057.9 | 1507233 | |
| St. Dev | 0.001 | 0.001 | 0.006 | 2.935 | 0.106 | 975.388 | 114058.262 | |
| COV | 0.261 | 0.606 | 5.344 | 4.535 | 5.687 | 4.632 | 7.567 | |

Table 2 provides data for four samples each of Ex 1 and Ex 2 as provided in Table 1, which were tested according to ASTM E1354-09: E1354-09 Standard Test Method for Heat and Visible Smoke Release Rates for Materials and Products Using an Oxygen Consumption Calorimeter.

TABLE 2

| | | | | | | | Average | | | | | | | Average | |
|---|---|---|---|---|---|---|---|---|---|---|---|---|---|---|---|
| | | | | | | | Effective | Avg. | Avg. | Avg. | | Time | | Specific | |
| | Incident | | Flame | | Total | | Heat | HRR at | HRR at | HRR at | Peak | of | Total | Extinction | Avg. |
| | Heat | Time to | Dura- | Initial | Mass | % | of Com- | 50 sec | 100 sec | 300 sec | HRR | Peak | HRR/A | Area | CO |
| | Flux | Ignition | tion | Mass | Loss | Mass | bustion | (kW/ | (kW/ | (kW/ | (kW/ | HRR | (MJ/ | (m²/ | Yield |
| Example | ( [symbol] ) | (sec) | (sec) | (g) | (g) | Loss | (MJ/kg) | m²) | m²) | m²) | m²) | (sec) | m [symbol] ) | kg) | (g/g) |
| Example 1 | 36.0 | 68.0 | 1048.8 | 46.8 | 26.1 | 86.8% | 33.8 | 130.8 | 111.0 | 195.3 | 157.5 | 24.0 | 82.5 | 358.8 | 0.0201 |
| (1) | | | | | | | | | | | | | | | |
| Example 1 | 35.0 | 54.0 | 999.0 | 47.2 | 26.3 | 60.6% | 34.2 | 141.4 | 122.6 | 114.1 | 174.2 | 22.0 | 86.5 | 395.3 | 0.0171 |
| (2) | | | | | | | | | | | | | | | |
| Example 1 | 35.0 | 52.0 | 950.1 | 47.6 | 27.0 | 58.7% | 35.4 | 144.7 | 125.7 | 122.2 | 173.4 | 25.0 | 86.3 | 314.8 | 0.0172 |
| (3) | | | | | | | | | | | | | | | |
| Example 1 | 36.0 | 51.0 | 1124.3 | 47.5 | 26.4 | 86.6% | 38.8 | 163.1 | 133.6 | 125.4 | 186.8 | 24.0 | 101.9 | 411.2 | 0.0227 |
| (4) | | | | | | | | | | | | | | | |
| Average | 35.0 | 53.3 | 1030.0 | 47.3 | 28.2 | 68.4% | 35.2 | 142.5 | 122.5 | 116.8 | 173.0 | 23.8 | 92.3 | 357.1 | 0.0193 |
| Example 2 | 35.0 | 64.0 | 563.5 | 57.8 | 19.4 | 35.6% | 39.7 | 188.0 | 165.9 | 177.7 | 214.9 | 18.0 | 77.10 | 624.2 | 0.0283 |
| (1) | | | | | | | | | | | | | | | |
| Example 2 | 35.0 | 85.0 | 646.6 | 67.0 | 20.5 | 38.0% | 37.6 | 186.8 | 167.8 | 179.7 | 223.8 | 22.0 | 77.1 | 657.7 | 0.0352 |
| (2) | | | | | | | | | | | | | | | |
| Example 2 | 35.0 | 50.0 | 869.1 | 56.7 | 20.8 | 37.3% | 37.3 | 180.0 | 151.7 | 158.8 | 204.1 | 324.7 | 77.51 | 597.4 | 0.0338 |
| (3) | | | | | | | | | | | | | | | |
| Average | 35.0 | 80.3 | 534.4 | 56.8 | 20.2 | 35.5% | 38.2 | 177.3 | 161.7 | 174.7 | 214.3 | 149.2 | 77.2 | 626.4 | 0.0324 |

[symbol]

indicates data missing or illegible when filed

FIG. 4A shows the change in Heat Release over time of a polymeric material tested using ASTM E 1354 which is known to pass UL2335. Polymeric materials that show significant reduction in both peak heat release rate as well as average heat release properties over time will therefore have a high confidence in being able to pass UL 2335. FIGS. 4B and 4C illustrates the heat release from two Examples of the polymeric composite material provided here (Ex 1 and Ex 2 as discussed herein). FIGS. 4 B and 4C show the change in Heat Release over time of Ex 1 and Ex 2 being lower than the Heat Release values shown in FIG. 4A.

The following examples (Ex) and comparative examples (ComEx) in Tables 3-6 help to further demonstrate the polymeric composite material of the present disclosure. The percent values shown in Tables 3-6 are weight percent of the polymeric composite material.

TABLE 3

| | Com Ex A | Ex 3 | Com Ex B | Ex 4 | Com Ex C | Com Ex D | Com Ex E | Com Ex F |
|---|---|---|---|---|---|---|---|---|
| Polyolefin: PP | 60.0% | 59.0% | 53.0% | 52.0% | 43.0% | 42.0% | 33.0% | 32.0% |
| Long Glass Fiber Reinforce | 30.0% | 30.0% | 30.0% | 30.0% | 30.0% | 30.0% | 30.0% | 30.0% |
| Flame Ret: Mag. Hyd. | 8.0% | 8.0% | 15.0% | 15.0% | 25.0% | 25.0% | 35.0% | 35.0% |
| Additive: Neph. Syenite | | | | | | | | |
| Additive: Black color | 2.0% | 2.0% | 2.0% | 2.0% | 2.0% | 2.0% | 2.0% | 2.0% |
| Coupling Agent | 0.0% | 1.0% | 0.0% | 1.0% | 0.0% | 1.0% | 0.0% | 1.0% |
| Measured Density (g/cc) | 1.184 | 1.155 | 1.245 | 1.214 | 1.317 | 1.299 | 1.424 | 1.460 |
| Tensile Strength Actual (MPa) | 63 | 94 | 58 | 68 | 49 | 61 | 46 | 48 |
| Specific Strength Actual (MPa) | 53 | 81 | 46.6 | 56 | 37 | 47.1 | 32 | 33 |
| Flexural Modulus (MPa) | 5271 | 6115 | 7601 | 6900 | 7753 | 7637 | 9754 | 10027 |
| Specific Stiffness (KN m/kg) | 4452 | 5296 | 6108 | 5684 | 5886 | 5881 | 6851 | 6867 |
| Cone Calorimetry (Peak HRR) | 349 | 388 | 247 | 356 | 223 | 231 | 113 | 170 |
| Cone Calorimetry (Average HRR) | 270 | 272 | 188 | 277 | 162 | 170 | 93 | 133 |
| Cone Calorimetry (Time (s) of Average | 300 | 300 | 180 | 180 | 60 | 60 | 180 | 60 |
| HRR) | | | | | | | | |

TABLE 4

| | Ex 5 | Ex 6 | Com Ex G | Ex 7 | Ex 8 | Ex 9 | Ex 10 | Ex 11 | Ex 12 |
|---|---|---|---|---|---|---|---|---|---|
| Polyolefin: PP | 77.4% | 69.6% | 76.4% | 68.6% | 68.0% | 67.4% | 59.6% | 66.4% | 58.6% |
| Long Glass Fiber Reinforce | 20.0% | 20.0% | 20.0% | 20.0% | 25.0% | 30.0% | 30.0% | 30.0% | 30.0% |
| Flame Ret: Mag. Hyd. | 0.1% | 7.9% | 0.1% | 7.9% | 4.0% | 0.1% | 7.9% | 0.1% | 7.9% |
| Additive: Neph. Syenite | | | | | | | | | |
| Additive: Black color | 2.0% | 2.0% | 2.0% | 2.0% | 2.0% | 2.0% | 2.0% | 2.0% | 2.0% |
| Coupling Agent | 0.5% | 0.5% | 1.5% | 1.5% | 1.0% | 0.5% | 0.5% | 1.5% | 1.5% |
| Measured Density (g/cc) | 1.019 | 1.067 | 1.010 | 1.074 | 1.084 | 1.100 | 1.155 | 1.097 | 1.163 |
| Tensile Strength Actual (MPa) | 81 | 70 | 71 | 86 | 83 | 97 | 79 | 94 | 103 |
| Specific Strength Actual (MPa) | 80 | 66 | 70 | 80 | 77 | 88 | 69 | 86 | 89 |
| Flexural Modulus (MPa) | 4270 | 3800 | 3448 | 5478 | 5463 | 5980 | 5784 | 5425 | 6599 |
| Specific Stiffness (KN m/kg) | 4191 | 3561 | 3413 | 5102 | 5039 | 5434 | 5008 | 4947 | 5676 |
| Cone Calorimetry (Peak HRR) | 381 | 455 | 455 | 396 | 449 | 427 | 389 | 326 | 355 |
| Cone Calorimetry (Average HRR) | 311 | 354 | 368 | 314 | 369 | 341 | 317 | 268 | 270 |
| Cone Calorimetry (Time (s) of Average | 300 | 300 | 300 | 300 | 300 | 300 | 300 | 300 | 300 |
| HRR) | | | | | | | | | |

TABLE 5

| | | | Com | Com | Com | Com | Com | | | |
|---|---|---|---|---|---|---|---|---|---|---|
| | Ex 13 | Ex 14 | Ex H | Ex I | Ex J | Ex K | Ex L | Ex 15 | Ex 16 | Ex 17 |
| Polyolefin: PP | 63.0% | 53.0% | 78.0% | 38.0% | 48.0% | 75.0% | 35.0% | 45.0% | 57.4% | 47.5% |
| Long Glass Fiber Reinforce | 25.0% | 25.0% | 10.0% | 10.0% | 40.0% | 10.0% | 10.0% | 40.0% | 40.0% | 50.0% |
| Flame Ret: Mag. Hyd. | 4.0% | 4.0% | 0.0% | 40.0% | 0.0% | 0.0% | 40.0% | 0.0% | 0.0% | 0.0% |
| Additive: Neph. Syenite | 5.0% | 15.0% | 10.0% | 10.0% | 10.0% | 10.0% | 10.0% | 10.0% | 0.0% | 0.0% |
| Additive: Black color | 2.0% | 2.0% | 2.0% | 2.0% | 2.0% | 2.0% | 2.0% | 2.0% | 2.0% | 2.0% |
| Coupling Agent | 1.0% | 1.0% | | | | 3.0% | 3.0% | 3.0% | 0.6% | 0.5% |
| Measured Density (g/cc) | 1.140 | 1.225 | 0.987 | 1.238 | 1.289 | 0.985 | 1.310 | 1.307 | 1.196 | 1.194 |
| Tensile Strength Actual (MPa) | 79 | 79 | 35 | 52 | 68 | 54 | 53 | 110 | 108 | 114 |
| Specific Strength Actual | 69 | 65 | 36 | 42 | 53 | 55 | 41 | 84 | 90 | 96 |
| (MPa) | | | | | | | | | | |
| Flexural Modulus (MN) | 5098 | 5932 | 2098 | 3835 | 8737 | 3032 | 4178 | 9563 | 7799 | 10817 |
| Specific Stiffness (KN m/kg) | 4473 | 4842 | 2125 | 3098 | 6780 | 3077 | 3189 | 7319 | 6521 | 9057 |
| Cone Calorimetry (Peak | 410 | 344 | 697 | 210 | 303 | 603 | 197 | 318 | 387 | 292 |
| HRR) | | | | | | | | | | |
| Cone Calorimetry (Average | 317 | 295 | 476 | 168 | 219 | 420 | 127 | 242 | 279 | 208 |
| HRR) | | | | | | | | | | |
| Cone Calorimetry (Time (s) of | 300 | 300 | 180 | 300 | 180 | 180 | 300 | 180 | 300 | 180 |
| Average HRR) | | | | | | | | | | |

TABLE 6

| | Com Ex M | Ex 18 | Ex 19 | Ex 20 | Ex 21 |
|---|---|---|---|---|---|
| Polyolefin: PP | 57.0% | 57.0% | 57.0% | 56.0% | 55.0% |
| Long Glass Fiber Reinforce | 30.0% | 20.0% | 20.0% | 20.0% | 20.0% |
| Flame Ret: Mag. Hyd. | 0.0% | 10.0% | 10.0% | 10.0% | 10.0% |
| Additive: Neph. Syenite | 10.0% | 10.0% | 10.0% | 10.0% | 10.0% |
| Additive: Black color | 2.0% | 2.0% | 2.0% | 2.0% | 2.0% |
| Coupling Agent | 1.0% | 1.0% | 1.0% | 2.0% | 3.0% |
| Measured Density (g/cc) | 1.134 | 1.171 | 1.157 | 1.164 | 1.177 |
| Tensile Strength Actual (MPa) | 79 | 64 | 69 | 71 | 73 |
| Specific Strength Actual (MPa) | 69 | 55 | 60 | 61 | 62 |
| Flexural Modulus (MPa) | 5169 | 4472 | 4130 | 4123 | 4351 |
| Specific Stiffness (KN m/kg) | 4557 | 3820 | 3569 | 3542 | 3698 |
| Cone Calorimetry (Peak HRR) | 338 | 337 | 372 | 373 | 401 |
| Cone Calorimetry (Average HRR) | 280 | 285 | 323 | 320 | 320 |
| Cone Calorimetry (Time (s) of Average | 300 | 180 | 180 | 180 | 180 |
| HRR) | | | | | |

Tables 3 through 6 show the possible formulas that which a flame retardant pallet can be made. Furthermore they show the corresponding performance criteria of interest for each formula. This criteria includes strength criteria as well as flammability performance criteria.

1. A flame retardant pallet, comprising:
at least one structural component formed from a polymeric composite material comprising:
35 weight percent (wt. %) to 78 wt. % of a polyolefin;
20 wt. % to 50 wt. % of a long glass fiber reinforcement;
0.5 wt. % to 3 wt. % of a coupling agent coupling the long glass fiber reinforcement to the polyolefin; and
up to 25 wt. % of a flame retardant, wherein the wt. % values of the polymeric composite material are based on a total weight of the polymeric composite material and total to a value of 100 wt. %, and the polymeric composite material used to form the structural component has a specific strength of at least 55 kN·m/kg and a specific stiffness of at least 3500 kN·m/kg as tested according to ASTM D638-10 (tensile strength) and D790-00 (flex modulus), which were each divided by the specific gravity (determined through ASTM D792-08) to arrive at the given values.

2. The flame retardant pallet of claim 1, wherein the flame retardant pallet weights from 15.9 kilograms (kg) to 27.2 kg.

3. The flame retardant pallet of claim 1, wherein the polyolefin is polypropylene.

4. The flame retardant pallet of claim 3, wherein the polypropylene has a melt flow index from 28 to 38 as measured according to ASTM D1238.

5. The flame retardant pallet of claim 1, wherein the polymeric composite material includes 0.1 wt. % to less than 8 wt. % of the flame retardant.

6. The flame retardant pallet of claim 1, wherein the flame retardant is magnesium hydroxide.

7. The flame retardant pallet of claim 1, wherein the long glass fiber has an aspect ratio of 700.

8. The flame retardant pallet of claim 1, further including a filler selected from the group consisting of carbon fiber, aramid fiber, natural fiber, talc, calcium carbonate, mica, wollastonite, milled fiberglass, and fiberglass solid spheres, and fiberglass hollow spheres, nepheline syenite and combinations thereof.

9. The flame retardant pallet of claim 1, wherein the coupling agent is maleic anhydride.

10. The flame retardant pallet of claim 1, wherein the polymeric composite material includes 45 wt. % to 57.4 wt. % of the polyolefin; 30 wt. % to 50 wt. % of the long glass fiber reinforcement; 0.5 wt. % to 3 wt. % of the coupling agent; and 0 wt. % of the flame retardant.

11. The flame retardant pallet of claim 1, wherein the polymeric composite material includes 53 wt. % to 69.6 wt. % of the polyolefin; 20 wt. % to 30 wt. % of the long glass fiber reinforcement; 0.5 wt. % to 1.5 wt. % of the coupling agent; and 0.1 wt. % to 7.9 wt. % of the flame retardant.

12. The flame retardant pallet of claim 1, wherein the polymeric composite material includes 52 wt. % to 59 wt. % of the polyolefin; 20 wt. % to 30 wt. % of the long glass fiber reinforcement; 1.0 wt. % to 3 wt. % of the coupling agent; and 8 wt. % to 15 wt. % of the flame retardant.

13. The flame retardant pallet of claim 1, wherein the polyolefin is polypropylene, the coupling agent is maleic anhydride and the flame retardant is magnesium hydroxide.

14. The flame retardant pallet of claim 1, wherein the at least one structural component is selected from the group consisting of a bottom deck, a top deck, a deck spacer and a combination thereof.

15. The flame retardant pallet of claim 14, where the wherein the flame retardant pallet further includes a reinforcement member at least partially encapsulated in the polymeric composite material of the top deck and/or the bottom deck of the flame retardant pallet.

16. The flame retardant pallet of claim 14, further including a skid resistant surface in the top deck of the flame retardant pallet.

17. A method of forming at least one component of a flame retardant pallet, comprising:
extruding a polymeric composite material comprising:
35 weight percent (wt. %) to 78 wt. % of a polyolefin;
20 wt. % to 50 wt. % of a long glass fiber reinforcement;
0.5 wt. % to 3 wt. % of a coupling agent that couples the long glass fiber reinforcement to the polyolefin; and
up to 25 wt. % of a flame retardant, wherein the wt. % values of the polymeric composite material are based on a total weight of the polymeric composite material and total to a value of 100 wt. %; and
molding the at least one structural component of the flame retardant pallet from the polymeric composite material.

18. The method of claim 17, wherein molding the at least one structural component includes transfer molding the at least one structural component.

19. The method of claim 17, wherein the at least one structural component of the pallet includes a top deck, a bottom deck and a deck spacer, wherein the method include assembling the top deck, the bottom deck and the deck spacer with a mechanical fastener to form the flame retardant pallet.

20. (canceled)

21. The method of claim 19, including forming a reinforcement channel around a reinforcement member in the top deck and/or and the bottom deck of the flame retardant pallet.

22.-24. (canceled)
